(19) United States
(12) Patent Application Publication
(10) Pub. No.: US 2024/0058943 A1
(43) Pub. Date: Feb. 22, 2024

(54) MOVING APPARATUS AND MOVING APPARATUS CONTROL METHOD

(71) Applicant: SONY GROUP CORPORATION, TOKYO (JP)

(72) Inventors: NORIAKI TAKASUGI, TOKYO (JP); MASAYA KINOSHITA, TOKYO (JP)

(21) Appl. No.: 18/260,652

(22) PCT Filed: Dec. 24, 2021
(86) PCT No.: PCT/JP2021/048263

§ 371 Date: Jul. 7, 2023

(30) Foreign Application Priority Data
Jan. 18, 2021 (JP) 2021-005545

(51) Int. Cl. B25J 5/00; B25J 9/16; B25J 19/02; G05D 1/02

(52) U.S. Cl. CPC B25J 5/007; B25J 9/1697; B25J 19/023; B25J 9/1664; G05D 1/0223

(57) ABSTRACT

Traveling according to a predefined target speed with each leg of a leg wheel robot grounded in a movement range corresponding to each leg can be performed even on a travel surface such as stairs. Travel surface information of the leg wheel robot that travels while alternately switching a grounding period in which traveling is performed with the wheels at the leg tips grounded to the travel surface and a free leg period in which the wheels at the leg tips are separated from the travel surface is acquired, a movement range corresponding to each leg in which the legs of the leg wheel robot can travel while being grounded to the travel surface is calculated, and track information of the legs for causing the leg wheel robot to travel with each leg grounded to the movement range corresponding to each leg according to a predefined target speed is generated.

### TECHNICAL FIELD

The present disclosure relates to a moving apparatus and a moving apparatus control method. Specifically, the present disclosure relates to a moving apparatus such as a leg wheel robot in which a wheel is mounted on a leg tip and which moves by performing both rotational driving of the wheel and leg driving for moving the leg forward and backward, and a moving apparatus control method.

### BACKGROUND ART

There is a leg wheel robot in which a wheel is mounted on a leg tip, as a robot capable of performing two different types of traveling processing, that is, walking type leg traveling of moving by moving a leg back and forth and wheel traveling of moving by rotating the wheel.

The leg wheel robot is a moving body having both high energy efficiency and uneven ground treading performance.

The leg wheel robot is capable of moving by wheels on a ground leveling portion with less unevenness in a travel surface, and capable of moving by cooperative operation of legs and wheels on stairs or a travel surface with many steps, so that the leg wheel robot can move on various traveling paths.

However, when the operation of simultaneously moving the legs while rotating the wheels, that is, when the wheel movement and the leg movement are performed in parallel, there is a high possibility that the balance of the robot cannot be maintained.

For example, in a case of going up stairs, it is ideal to perform an operation of stepping over a step of the stairs without stopping the wheels or the trunk. However, in this case, it is necessary to perform an operation of the robot of raising one of legs away from the ground contact surface while continuing the wheel traveling with any other one of the legs, and it is necessary to maintain the balance of the robot and determine the timing of raising the leg, which requires advanced control.

For example, in a case where a six-legged wheel robot having three leg wheels in each of the front and rear of the robot goes up stairs, it is necessary for the robot to move with at least three or more legs grounded in order to maintain the static stability of the robot.

However, for example, a case is assumed where all the six legs of the robot approach the wall of the stairs at the same time while the robot is traveling. In such a case, the robot has to stop once and raise the legs alternately by three wheels.

When the robot performs stop processing, as a result, the moving speed of the robot decreases.

For example, Patent Document 1 (Japanese Patent Application Laid-Open No. 2007-130701) and Patent Document 2 (Japanese Patent Application Laid-Open No. 10-236350) disclose conventional technologies related to stairs treading of a leg wheel robot.

Patent Document 1 (Japanese Patent Application Laid-Open No. 2007-130701) discloses a configuration in which a position of a predetermined margin from a wall of stairs is measured by a distance measuring sensor, a wheel movement is performed to the position, and leg movement is performed when the robot reaches a predetermined position.

As the order of the operation, the stairs treading is performed by repeating three patterns of a both-leg support period, a single-leg support period accompanied by free leg movement, and wheel movement.

However, the configuration disclosed in Patent Document 1 is based on the premise that the leg movement is performed after the wheel is stopped, and there is a problem that the operation becomes slow.

For example, one of the leg tip wheels has to stop until the other leg tip wheel steps on the next step. Furthermore, the configuration disclosed in Patent Document 1 is a configuration in which wheel movement is not performed in a case of single leg support, and this configuration also causes a low-speed operation.

Moreover, in the configuration, the wheel stops every time the wheel reaches the wall, and acceleration and deceleration are repeatedly performed, and there is also a problem that smooth movement cannot be performed.

Furthermore, Patent Document 2 (Japanese Patent Application Laid-Open No. 10-236350) discloses a stairs treading method using legs extensible in a vertical direction and traveling wheels. By repeating the wheel movement in the horizontal direction and the leg extension/contraction operation in the vertical direction, it is possible to go up and down stairs.

However, the robot disclosed in Patent Document 2 is a robot that cannot adjust the distance between the legs, and needs to be temporarily stopped before the leg moves up and down to get over a step.

Therefore, wheel movement cannot be performed while leg movement is performed, and only a low-speed operation can be performed.

Both of the conventional technologies disclosed in Patent Documents 1 and 2 described above require an operation of temporarily stopping wheels in order for the robot to step over a stair.

Therefore, as a result, the moving speed of the robot decreases as a problem.

### CITATION LIST

### Patent Document

Patent Document 1: Japanese Patent Application Laid-Open No. 2007-130701
Patent Document 2: Japanese Patent Application Laid-Open No. H10-236350

### SUMMARY OF THE INVENTION

### Problems to be Solved by the Invention

The present disclosure has been made in view of the problems described above, for example, and an object of the present disclosure is to provide a moving apparatus and a moving apparatus control method that enable high-speed and smooth movement of a leg wheel robot that performs wheel driving and leg driving.

For example, in an embodiment of the present disclosure, an operation method is achieved in which a position to which a robot moves in the future is predicted, a temporal and spatial range in which the robot can safely move is predicted from environment information of the movement range, and the robot smoothly moves within the range, so that the robot moves at a high speed without interfering with stairs.

### Solutions to Problems

A first aspect of the present disclosure is
a moving apparatus including
a data processing unit that generates control information for driving a leg wheel robot including a plurality of legs each including a wheel at a leg tip,
in which the data processing unit
acquires travel surface information of the leg wheel robot,
calculates a movement range corresponding to each of the legs in which the leg wheel robot can travel with the legs grounded to a travel surface, by using the travel surface information, and
generates track information of each of the legs for causing the leg wheel robot to travel with each of the legs grounded in the movement range corresponding to each of the legs.

Moreover, a second aspect of the present disclosure is
a moving apparatus control method of performing movement control of a leg wheel robot including a plurality of legs each including a wheel at a leg tip,
in which a data processing unit of the moving apparatus
acquires travel surface information of the leg wheel robot,
calculates a movement range corresponding to each of the legs in which the leg wheel robot can travel with the legs grounded to a travel surface, by using the travel surface information, and
generates track information of each of the legs for causing the leg wheel robot to travel with each of the legs grounded in the movement range corresponding to each of the legs.

Still other objects, features, and advantages of the present disclosure will be clarified by more detailed description based on an embodiment of the present disclosure and accompanying drawings as described later. Note that, in the present specification, a system is a logical set configuration of a plurality of devices, and is not limited to a system in which devices of configurations are in the same housing.

According to the configuration of an embodiment of the present disclosure, it is possible to achieve a configuration that enables each leg of the leg wheel robot to be grounded in a movement range corresponding to each leg and to travel according to a predefined target speed even on a travel surface such as a staircase.

Specifically, for example, travel surface information of the leg wheel robot that travels while alternately switching a grounding period in which the traveling is performed with wheels at the leg tips grounded to the travel surface and a free leg period in which the wheels at the leg tips are separated from the travel surface is acquired, a movement range corresponding to each leg in which the legs of the leg wheel robot can travel while being grounded to the travel surface is calculated, and track information of the leg for causing each leg of the leg wheel robot to travel according to a predefined target speed while being grounded to the movement range corresponding to each leg is generated.

According to this configuration, it is possible to achieve a configuration that enables each leg of the leg wheel robot to be grounded in a movement range corresponding to each leg and to travel according to a predefined target speed even on a travel surface such as a staircase.

Note that effects described in the present description are merely examples and are not limited, and additional effects may be provided.

### BRIEF DESCRIPTION OF DRAWINGS

FIG. 1 is a diagram describing a configuration example of a six-leg type leg wheel robot that is an example of a moving apparatus of the present disclosure.

FIG. 2 is a diagram describing the configuration example of the six-leg type leg wheel robot that is an example of the moving apparatus of the present disclosure.

FIG. 3 is a diagram describing a configuration example of a four-leg type leg wheel robot that is an example of the moving apparatus of the present disclosure.

FIG. 4 is a diagram describing the configuration example of the four-leg type leg wheel robot that is an example of the moving apparatus of the present disclosure.

FIG. 5 is a diagram describing a traveling example of a six-leg type leg wheel robot that is an example of the moving apparatus of the present disclosure.

FIG. 6 is a diagram describing a configuration and processing of the moving apparatus of the present disclosure.

FIG. 7 is a diagram describing an example of a gait parameter.

FIG. 8 is a diagram describing an example of traveling processing of a robot according to a gait parameter.

FIG. 9 is a diagram for explaining an example in which the leg wheel robot travels on stairs.

FIG. 10 is a diagram describing a target movement range in which grounding travel is performed during a grounding period of the leg.

FIG. 11 is a diagram describing the target movement range in which the grounding travel is performed during the grounding period of the leg.

FIG. 12 is a diagram describing a specific example of processing performed by a movable range determination unit.

FIG. 13 is a diagram describing a reason why traveling cannot be performed according to the target movement range in a case where a travel surface is stairs.

FIG. 14 is a diagram describing a specific example of corrected movement range generation processing performed by the movable range determination unit.

FIG. 15 is a diagram describing a specific example of movement of a front middle leg (FM) of the leg wheel robot at a timing of time t2 illustrated in FIG. 14.

FIG. 16 is a diagram describing a processing example of connecting a plurality of separated target movement ranges and setting the target movement ranges as a corrected movement range corresponding to one grounding period.

FIG. 17 is a diagram describing a difference in movement range setting before and after correction of the target movement range by the movable range determination unit.

FIG. 18 is a diagram describing a specific example of leg track generation processing performed by a track generation unit.

FIG. 19 is a diagram describing a specific example of the leg track generation processing performed by the track generation unit.

FIG. 20 is a diagram describing a specific example of the leg track generation processing performed by the track generation unit.

FIG. 21 is a diagram describing a processing example in a case where the leg wheel robot goes up spiral stairs.

FIG. 22 is a diagram describing an example of target gait data generated by a target gait generation unit in a case where a six-leg type leg wheel robot 1 travels up spiral stairs.

FIG. 23 is a diagram illustrating an example of data of a corrected movement range generated by correcting a target movement range in the grounding period of each leg in consideration of an actual travel surface.

FIG. 24 is a diagram illustrating a flowchart describing a track generation processing sequence of the leg of the moving apparatus performed by the moving apparatus of the present disclosure.

FIG. 25 is a diagram illustrating a flowchart describing the track generation processing sequence of the leg of the moving apparatus performed by the moving apparatus of the present disclosure.

FIG. 26 is a diagram illustrating a flowchart describing the track generation processing sequence of the leg of the moving apparatus performed by the moving apparatus of the present disclosure.

FIG. 27 is a diagram describing a hardware configuration example of the moving apparatus of the present disclosure.

FIG. 28 is a diagram describing a system configuration example including the moving apparatus of the present disclosure and a server.

FIG. 29 is a diagram describing a hardware configuration example of the server in the system configuration including the moving apparatus of the present disclosure and the server.

### MODE FOR CARRYING OUT THE INVENTION

Hereinafter, details of a moving apparatus and a moving apparatus control method of the present disclosure will be described with reference to the drawings. Note that the description will be given according to the following items.
1. Overview of moving apparatus of present disclosure
2. Configuration example of and processing performed by moving apparatus of present disclosure
3. Details of processing performed by target gait generation unit, movable range determination unit, and track generation unit
4. Other embodiments
5. Processing sequence of generating track of leg of moving apparatus performed by moving apparatus of present disclosure
6. Hardware configuration example of moving apparatus of present disclosure
7. Summary of configuration of present disclosure

### 1. Overview of Moving Apparatus of Present Disclosure

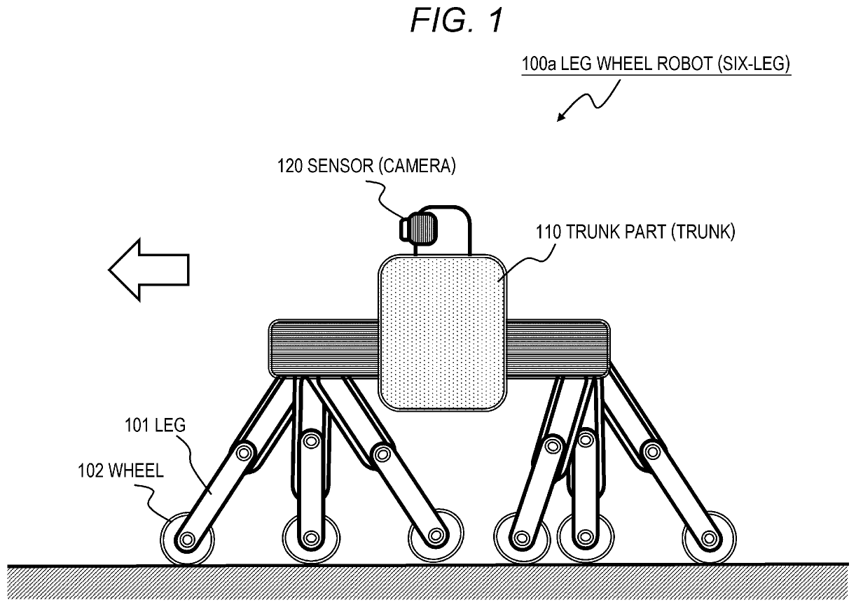

First, an overview of a moving apparatus of the present disclosure will be described with reference to FIG. 1 and so on.

FIG. 1 is a diagram illustrating a leg wheel robot 100a which is an example of the moving apparatus of the present disclosure.

The leg wheel robot 100a illustrated in FIG. 1 is a configuration example of a six-leg type leg wheel robot having three legs 101 on the front side and three legs 101 on the rear side.

A wheel 102 is mounted to a tip end of each leg 101. Wheel traveling can be performed by rotating the wheels 102, and leg movement, that is, walking traveling can be performed by lifting the legs 101 and moving them back and forth.

As illustrated in FIG. 1, the leg wheel robot 100a includes a trunk part (trunk) 110 and a sensor (camera) 120. The trunk part 110 is the trunk of the robot.

A control device (information processing device) for controlling the robot is mounted on the trunk part 110. Moreover, for example, an inertial measurement unit (IMU) is mounted, and the control device calculates the self-position of the robot by using measurement data of the IMU, and performs drive control of the robot on the basis of the calculation result.

The sensor 120 is, for example, a sensor such as a three-dimensional sensor for performing environment recognition in the traveling direction of the robot, and includes, for example, a camera that captures an image.

Note that, as the sensor 120, for example, any one of a stereo camera, an omnidirectional camera, an infrared camera, a light detection and ranging (LiDAR) sensor, a time of flight (TOF) sensor, or the like, or a combination thereof can be used.

Note that both the LiDAR and TOF sensors are sensors capable of measuring an object distance.

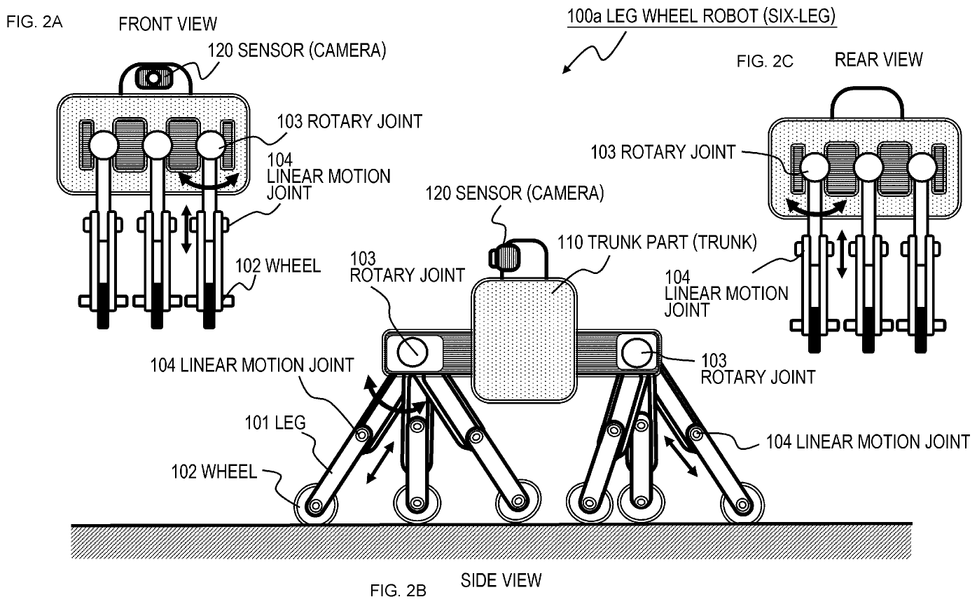

A detailed configuration of the leg wheel robot 100a illustrated in FIG. 1 will be described with reference to FIG. 2.

FIG. 2 illustrates three views of the leg wheel robot 100a illustrated in FIG. 1, that is,
(a) a front view,
(b) a side view, and
(c) a rear view.

As illustrated in each drawing, the wheels 102 are mounted to the tip ends of the six legs 101.

Moreover, a rotary joint 103 is provided at an upper end of each of the six legs 101, and a linear motion joint 104 is provided at a middle portion of the six legs 101.

The rotary joint 103 at the upper end of the leg is a joint part that enables each leg 101 to rotate in the front and rear direction and further rotate in the horizontal and right and left direction.

By rotating each leg 101 in the front and rear direction, movement by the legs of the robot, that is, walking traveling becomes possible.

Furthermore, the traveling direction of the robot can be controlled by rotating each leg 101 in the horizontal and right and left direction.

On the other hand, the linear motion joint in the leg middle portion is a joint part capable of controlling the length of each leg 101, and is a joint capable of extending and contracting the leg 101 in the leg length direction.

The control of these joint parts is performed by a control unit inside the robot.

As described above with reference to FIG. 1, a control device (information processing device) for controlling the robot is mounted on the trunk part 110. The control device inputs detection signals of a position sensor and an encoder mounted on each of the joint parts 103, 104, analyzes a position (three-dimensional position) and a motion of each leg by analyzing the input signals, and drives and controls the joint part of each leg on the basis of an analysis result.

Note that a configuration may be employed in which a torque sensor or a force sensor is mounted to each joint part or a leg tip, detection information is input to a control device (information processing device), and the detection information is used for drive control of the joint part of each leg in the control device (information processing device).

Note that, in the following embodiment, a configuration example will be described in which a control device (information processing device) for controlling and driving the robot is provided in the trunk part 110 of the robot, and the drive control of the robot is performed by the robot alone. However, the processing of the present disclosure is not limited to such a configuration, and can also be applied to a configuration in which an external device such as a server capable of communicating with the robot controls the robot.

The leg wheel robot 100a described with reference to FIGS. 1 and 2 is a six-leg type leg wheel robot, but the number of legs can be variously set.

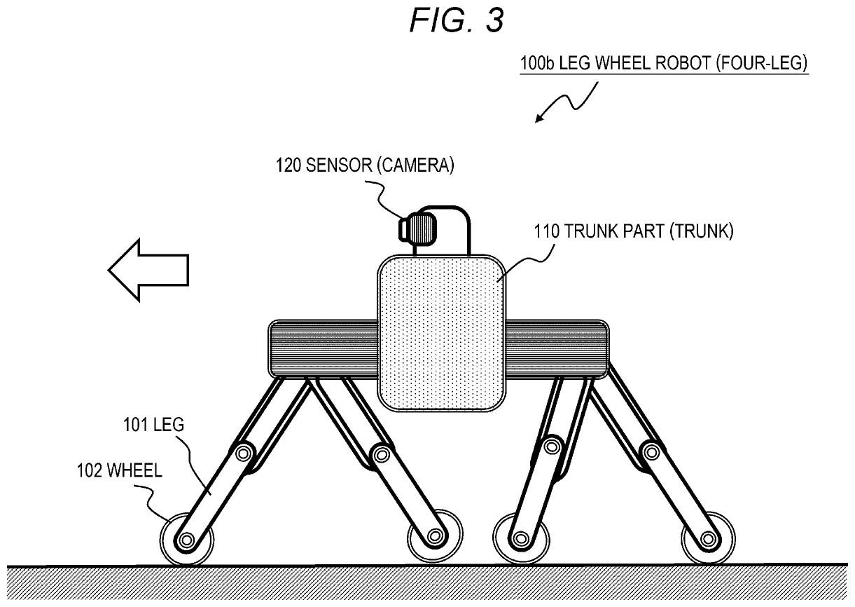

For example, FIG. 3 illustrates a four-leg type leg wheel robot 100b.

The leg wheel robot 100b illustrated in FIG. 3 is a configuration example of a four-leg type leg wheel robot having two legs 101 on the front side and two legs 101 on the rear side.

A wheel 102 is mounted to a tip end of each leg 101. Wheel traveling can be performed by rotating the wheels 102, and leg movement, that is, walking traveling can be performed by lifting the legs 101 and moving them back and forth.

The leg wheel robot 100b illustrated in FIG. 3 also includes a trunk part (trunk) 110 and a sensor (camera) 120 similarly to the six-leg type leg wheel robot 100a described above with reference to FIGS. 1 and 2.

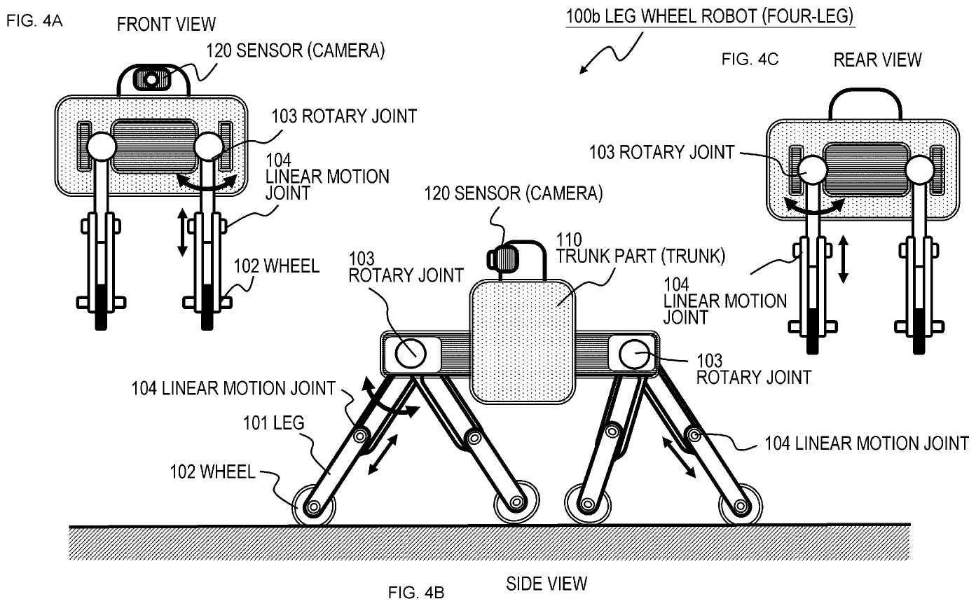

A detailed configuration of the leg wheel robot 100b illustrated in FIG. 3 will be described with reference to FIG. 4.

FIG. 4 illustrates three views of the leg wheel robot 100b illustrated in FIG. 3, that is,
(a) a front view,
(b) a side view, and
(c) a rear view.

As illustrated in each drawing, the wheels 102 are mounted to the tip ends of the four legs 101.

Moreover, a rotary joint 103 is provided at an upper end of each of the four legs 101, and a linear motion joint 104 is provided at a middle portion of the four legs 101.

The rotary joint 103 at the upper end of the leg is a joint part that enables each leg 101 to rotate in the front and rear direction and further rotate in the horizontal and right and left direction.

By rotating each leg 101 in the front and rear direction, movement by the legs of the robot, that is, walking traveling becomes possible.

Furthermore, the traveling direction of the robot can be controlled by rotating each leg 101 in the horizontal and right and left direction.

On the other hand, the linear motion joint in the leg middle portion is a joint part capable of controlling the length of each leg 101, and is a joint capable of extending and contracting the leg 101 in the leg length direction.

The control of these joint parts is performed by a control unit inside the robot.

The configuration example of the leg wheel robot 100 that is an example of the moving apparatus of the present disclosure has been described above with reference to FIGS. 1 to 4.

The moving apparatus of the present disclosure is a robot in which wheels are mounted to a plurality of legs as described above, and has a configuration in which wheel traveling can be performed by rotating the wheels, and leg movement, that is, walking traveling can be performed by lifting the legs and moving them back and forth.

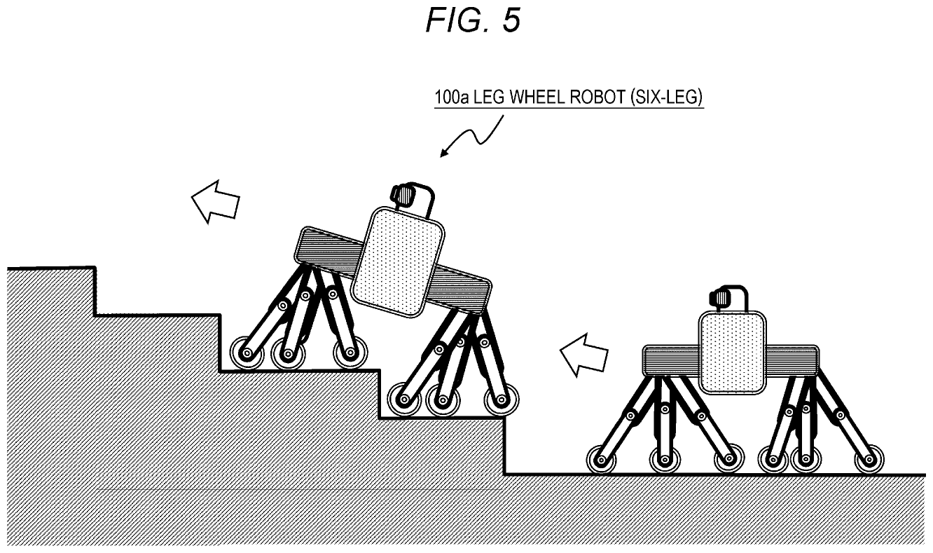

A traveling example of a leg wheel robot that is the moving apparatus of the present disclosure will be described with reference to FIG. 5.

FIG. 5 illustrates the six-leg type leg wheel robot 100a that goes up stairs.

In general, in a case where the leg wheel robot moves up and down stairs, operation control is often performed in which the robot is temporarily stopped at the timing of going up or down the steps of the stairs.

This is because if the robot is raised without stopping the robot, the robot may lose its balance and fall.

In order to eliminate the possibility of falling, an operation sequence of stopping the robot, performing posture control of the robot, then selecting a leg to be raised, changing the posture to a posture considering the balance in a case where the leg is raised, and then raising the leg is generally performed.

However, when such an operation sequence is performed for each step of the stairs, the moving speed of the robot significantly decreases.

The leg wheel robot, which is the moving apparatus of the present disclosure, has a configuration that prevents such a decrease in the moving speed and enables moving up and down of stairs without accompanying a stop operation as much as possible.

Hereinafter, a detailed configuration and processing of the leg wheel robot of the present disclosure will be described.

### 2. Configuration Example of and Processing Performed by Moving Apparatus of Present Disclosure

Next, configuration example of and processing performed by moving apparatus of present disclosure will be described.

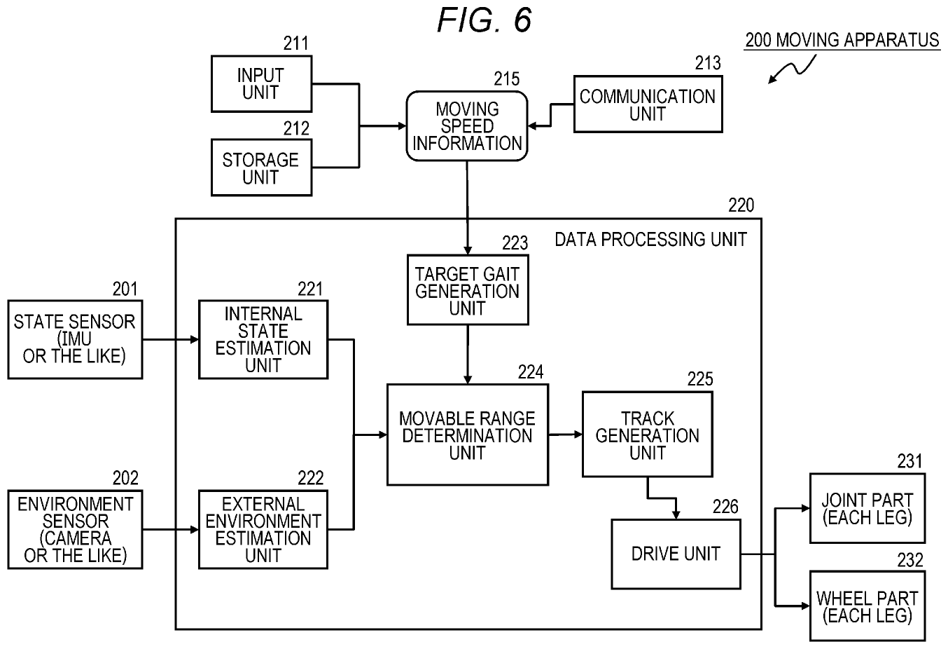

FIG. 6 is a block diagram describing an example of a configuration of the moving apparatus of the present disclosure.

The moving apparatus 200 illustrated in FIG. 6 is, for example, the leg wheel robot described with reference to FIGS. 1 to 4.

As illustrated in FIG. 6, the moving apparatus 200 includes a state sensor 201, an environment sensor 202, an input unit 211, a storage unit 212, a communication unit 213, a data processing unit 220, a joint part 231, and a wheel part 232.

The data processing unit 220 includes an internal state estimation unit 221, an external environment estimation unit 222, a target gait generation unit 223, a movable range determination unit 224, a track generation unit 225, and a drive unit 226.

The state sensor 201 includes a sensor for observing an internal state of the robot, for example, an internal state such as a position, a speed, an acceleration, a gradient, and a center of gravity, for example, a sensor such as an inertial measurement unit (IMU), a position sensor mounted on a joint part of a leg of the robot, and an encoder.

The acquired information of the state sensor 201 is input to the internal state estimation unit 221 of the data processing unit 220.

The environment sensor 202 is a sensor for analyzing an external environment of the robot, and is, for example, any one of a stereo camera, an omnidirectional camera, an infrared camera, a light detection and ranging (LiDAR) sensor, a time of flight (TOF) sensor, or the like, or a combination thereof can be used.

Note that both the LiDAR and TOF sensors are sensors capable of measuring an object distance.

The acquired information of the environment sensor 202 is input to the external state estimation unit 222 of the data processing unit 220.

Moreover, moving speed information 215 is input to the data processing unit 220. The moving speed information 215 is a predefined scheduled moving speed of the robot. The moving speed information 215 may be input by a user (operator) via the input unit 211, or information stored in advance in the storage unit 212 may be used as the moving speed information 215. Alternatively, the moving speed information 215 may be received and input from a control device such as an external server via the communication unit 213.

Next, the configuration and processing of the data processing unit 220 will be described.

The data processing unit 220 is configured in the control device (information processing device) in the trunk part (trunk) 110 of the robot described above with reference to FIG. 1 and the like.

Note that, as described above, the data processing unit 220 illustrated in FIG. 6 may be configured so as to be set in an external device such as a server that can communicate with the robot, for example.

The data processing unit 220 includes an internal state estimation unit 221, an external environment estimation unit 222, a target gait generation unit 223, a movable range determination unit 224, a track generation unit 225, and a drive unit 226.

The internal state estimation unit 221 inputs detection information of the state sensor 201 and analyzes the state of the robot.

Specifically, the internal state such as a position, a speed, an acceleration, an inclination, and a center of gravity of the robot is analyzed.

Moreover, input information from a position sensor and an encoder mounted on the joint part of the leg of the robot is analyzed to analyze the position (three-dimensional position) and movement of each leg.

Specifically, the internal state estimation unit 221 acquires sensor information such as the IMU and the encoder, and estimates the current position and posture of the trunk of the robot, the position of the toe, and differential information (speed, acceleration, and the like) thereof. Moreover, the internal state estimation unit 221 calculates the position of the center of gravity and the speed by using the obtained trunk information.

Note that the internal state estimation unit 221 may perform processing of estimating the position and posture of the trunk from external sensor information such as a three-dimensional sensor.

The analysis result of the internal state estimation unit 221 is input to the movable range determination unit 224.

For example, internal state information such as the current position and posture of the trunk of the robot, the position of the center of gravity, the speed, the position of each leg, the speed, and the acceleration is input to the movable range determination unit 224.

The external environment estimation unit 222 inputs detection information of the environment sensor 202 and analyzes the environment outside the robot.

The external environment estimation unit 222 estimates the external environment by inputting sensor detection information from an environment sensor 203 including a three-dimensional sensor such as a camera or a radar. Specifically, the three-dimensional shape of the object on the travel surface and the traveling direction of the robot is analyzed.

The external environment estimation unit 222 sequentially combines time-series data input from the environment sensor 203 including a three-dimensional sensor such as a camera or a radar, for example, to generate a wide range of environment information (map information) around the robot.

The external environment estimation unit 222 sequentially synthesizes the time-series data input from the environment sensor 203 to generate a map such as a height map. The height map is map data in which height data (z) is recorded in association with a representative coordinate position of two-dimensional coordinates (x, y) on an xy horizontal plane.

Note that the height map is an example of a three-dimensional map as environment information generated by the external environment estimation unit 222, and the environment information generated by the external environment estimation unit 222 is not limited to the height map, and various expression formats such as a three-dimensional point cloud (PC), voxel expression, and a primitive shape group using object detection can be used.

The environment information generated by the external environment estimation unit 222, for example, three-dimensional map data is input to the movable range determination unit 224.

The target gait generation unit 223 generates target gait data on the basis of the moving speed information 215.

As described above, the moving speed information 215 is a predefined scheduled moving speed of the robot, may be input by a user (operator) via the input unit 211, or information stored in advance in the storage unit 212 may be used as the moving speed information 215. Alternatively, the moving speed information 215 may be received and input from a control device such as an external server via the communication unit 213.

The target gait generation unit 223 generates target gait data, that is, target motion sequence data of the robot on the basis of the moving speed information 215 and the predefined target gait parameter. Specifically, a target track such as a leg tip position, a trunk position, and a posture of the target is determined.

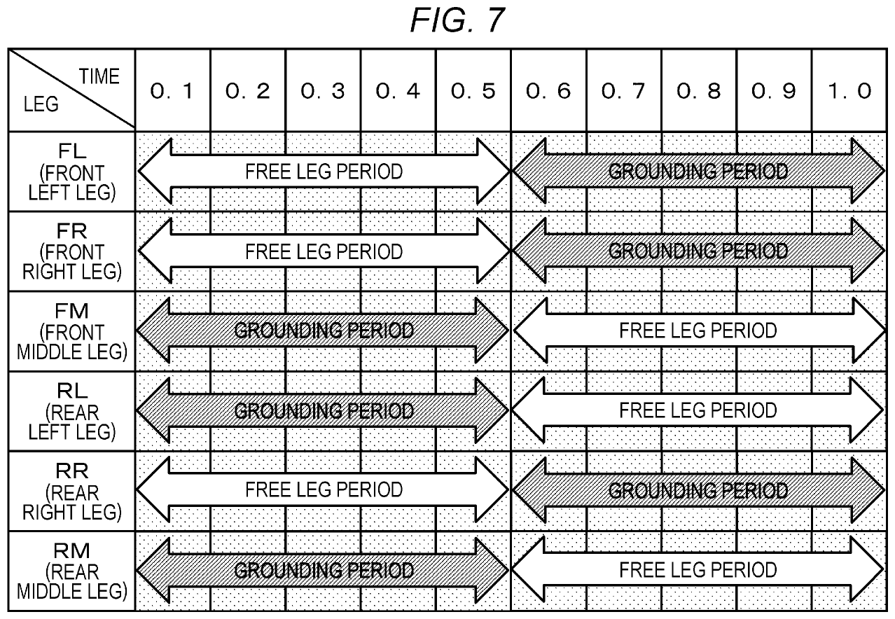

FIG. 7 illustrates an example of the target gait parameter used to generate the target gait data. The target gait parameter is acquired from the memory in the target gait generation unit 223 or the data processing unit 220. Alternatively, the target gait parameter may be input via the input unit 211, the storage unit 212, and the communication unit 213.

FIG. 7 illustrates a chart in which the vertical axis represents each leg and the horizontal axis represents time. This chart shows the grounding period and the free leg period of each leg of the robot.

The grounding period is a period in which the wheel portion at the tip end of the leg is grounded to the travel surface and the wheel traveling by the rotation of the wheel is enabled.

On the other hand, the free leg period is a period in which the wheel portion at the tip end of the leg is not grounded to the travel surface and is separated from the travel surface, and the wheel traveling by the rotation of the wheel is disabled.

FL, FR, FM, RL, RR, and RM indicate the front left leg, the front right leg, the front middle leg, the rear left leg, the rear right leg, and the rear middle leg, respectively. The horizontal axis represents time or a ratio obtained by normalizing time.

At the switching timing between the grounding period and the free leg period, for example, processing of controlling the linear motion joint 104 of each leg to change the length of the leg, processing of rotating the rotary joint 103, and the like are performed, and the grounding processing for the travel surface of each leg and the separation processing from the travel surface are performed by these controls.

Note that, in the free leg period, for example, the leg can be rotated back and forth by rotating the rotary joint 103. For example, the leg is rotated in the forward direction, the linear motion joint is controlled at the subsequent grounding period start timing, the length of the leg is increased, and the grounding is performed, and thereby the forward movement by walking becomes possible.

FIG. 7 illustrates the grounding period and the free leg period of each of the six legs of the six-leg type leg wheel robot in a period of 10 units (0.1˜1.0) of 0.1 unit hours.

Specifically, the grounding period and the free leg period of each of the six legs are set as follows.

In the period of time 0.1˜0.5,
three legs of a front left leg (FL), a front right leg (FR), and a rear right leg (RR) are in the free leg period, and
three legs of a front middle leg (FM), a rear right leg (RL), and a rear middle leg (RM) are in the grounding period.

In the period of time 0.6˜1.0,
three legs of the front middle leg (FM), the rear right leg (RL), and the rear middle leg (RM) are in the free leg period, and
three legs of the front left leg (FL), the front right leg (FR), and the rear right leg (RR) are in the grounding period.

As described above, the data is obtained by setting the grounding period and the free leg period of each of the six legs of the six-leg type leg wheel robot.

The chart illustrated in FIG. 7 illustrates a sequence of traveling while alternately switching between the grounding period and the free leg period every three legs. This sequence is data defining the motion sequence of the target leg, that is, the target gait parameter.

Note that FIG. 7 illustrates only data of one switching unit during the time 0.1 to 1.0 of the travel sequence in which the grounding period and the free leg period are alternately switched for every three legs. However, in a case where the robot continuously travels, the alternate switching travel of the grounding period and the free leg period for every three legs illustrated in FIG. 7 is repeatedly performed.

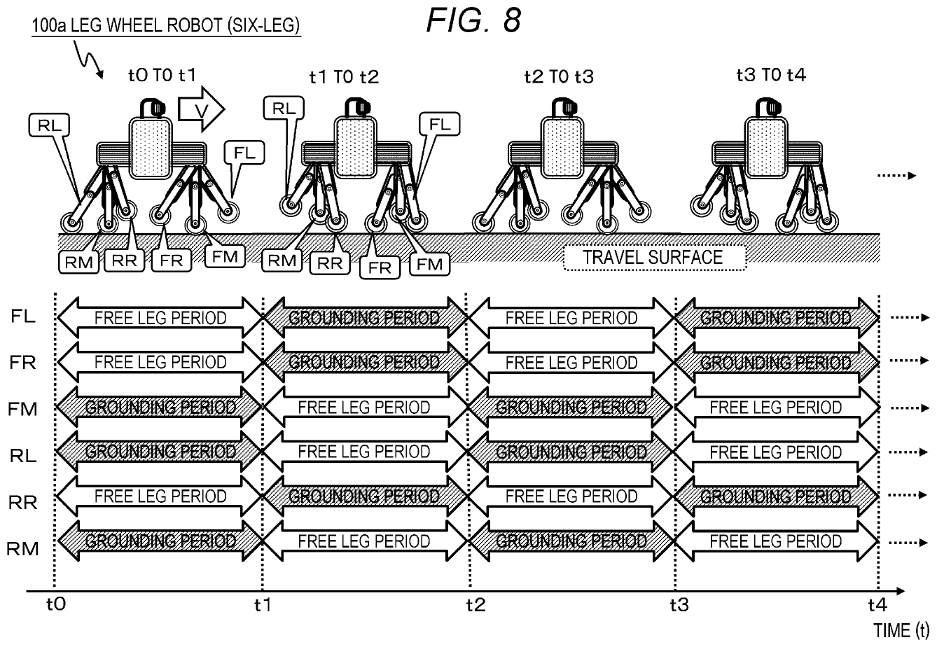

FIG. 8 illustrates a specific example of a case where the six-leg type leg wheel robot 100a travels according to the target gait parameters illustrated in FIG. 7.

FIG. 8 illustrates an example in which the six-leg type leg wheel robot 100a is traveling at a constant speed at a speed V on a horizontal travel surface.

FIG. 8 illustrates the traveling state of the leg wheel robot 100a in four time zones as described below.
time=t1 to t2
time=t2 to t3
time=t3 to t4
time=t4 to t5
time t1 to t2 is a time corresponding to the time=0.1 to 0.5 illustrated in FIG. 7.

In the setting of the gait parameter in FIG. 7, three legs of a front left leg (FL), a front right leg (FR), and a rear right leg (RR) are in the free leg period, and three legs of the front middle leg (FM), the rear right leg (RL), and the rear middle leg (RM) are in the grounding period.

The leg wheel robot 100a from time t1 to t2 illustrated in FIG. 8 is set according to this gait parameter, and is set to a state in which the three legs of the front left leg (FL), the front right leg (FR), and the rear right leg (RR) are not grounded to the travel surface, that is, the free leg state.

On the other hand, the other three legs of the front middle leg (FM), the rear right leg (RL), and the rear middle leg (RM) are in a state of being grounded to the travel surface, and the leg wheel robot 100a travels at a speed V by the rotation of the wheels at the tip ends of the three grounded legs.
time t2 to t3 is a time corresponding to the time=0.6 to 1.0 illustrated in FIG. 7.

In the setting of the gait parameter in FIG. 7,
three legs of the front left leg (FL), the front right leg (FR), and the rear right leg (RR) are in the grounding period, and
three legs of the front middle leg (FM), the rear right leg (RL), and the rear middle leg (RM) are in the free leg period.

The leg wheel robot 100a from time t2 to t3 illustrated in FIG. 8 is set according to this gait parameter, and is set to a state in which the three legs of the front middle leg (FM), the rear right leg (RL), and the rear middle leg (RM) are not grounded to the travel surface, that is, the free leg state.

On the other hand, the other three legs of the front left leg (FL), the front right leg (FR), and the rear right leg (RR) are in a state of being grounded to the travel surface, and the leg wheel robot 100a travels at a speed V by the rotation of the wheels at the tip ends of the three grounded legs.

As similar to t0 to t1, time t2 to t3 is a time corresponding to the time=0.1 to 0.5 illustrated in FIG. 7. That is,

In the setting of the gait parameter in FIG. 7,
three legs of a front left leg (FL), a front right leg (FR), and a rear right leg (RR) are in the free leg period, and
three legs of the front middle leg (FM), the rear right leg (RL), and the rear middle leg (RM) are in the grounding period.

The leg wheel robot 100a from time t3 to t4 illustrated in FIG. 8 is set according to this gait parameter, and is set to a state in which the three legs of the front left leg (FL), the front right leg (FR), and the rear right leg (RR) are not grounded to the travel surface, that is, the free leg state.

On the other hand, the other three legs of the front middle leg (FM), the rear right leg (RL), and the rear middle leg (RM) are in a state of being grounded to the travel surface, and the leg wheel robot 100a travels at a speed V by the rotation of the wheels at the tip ends of the three grounded legs.

As similar to t1 to t2, time t3 to t4 is a time corresponding to the time=0.5 to 1.05 illustrated in FIG. 7.

Hereinafter, similar processing is repeatedly performed, and the robot can continuously travel while alternately switching between the free leg period and the grounding period of the three legs.

As described above, the target gait generation unit 223 generates target gait data, that is, target motion sequence data of the robot on the basis of the predefined moving speed information 215 and the predefined target gait parameter as illustrated in FIG. 7. Specifically, the target track such as the leg tip position, the trunk position, and the posture of the target is determined as the “target gait”, that is, the target motion sequence.

The “target gait” determined by the target gait generation unit 223, that is, the target motion sequence information is input to the movable range determination unit 224.

Each of the following pieces of information is input to the movable range determination unit 224.
(a) Internal state information such as the current position and posture of the trunk of the robot, the position of the center of gravity, the speed, the position of each leg, the speed, and the acceleration from the internal state estimation unit 221
(b) Environment information such as three-dimensional map data generated by the external environment estimation unit 222
(c) Target gait indicating the target track such as a leg tip position, a body trunk position, and a posture of the target (target track such as a leg tip position, a trunk position, and posture of the target) generated by the target gait generation unit 223

The movable range determination unit 224 uses these pieces of input information (a) to (c) to correct the “target gait (target track such as a leg tip position, a trunk position, and posture of the target)” input so that the robot can move at the target speed, and determines the movable range of the wheel at the tip end of each leg of the robot.

Details of the processing performed by the movable range determination unit 224 will be described later.

The movable range information of the wheel at the tip end of each leg of the robot determined by the movable range determination unit 224 is input to the track generation unit 225.

The track generation unit 225 refers to the movable range of the wheel of the tip end of each leg of the robot determined by the movable range determination unit 224, and generates a track of each leg that satisfies the condition that the wheel of the tip end of each leg is set within the movable range and that enables smooth movement according to a predefined moving speed, that is, the speed of the “moving speed information 215” illustrated in FIG. 6.

Details of the processing performed by the track generation unit 225 will also be described later.

The track information of each leg of the robot generated by the track generation unit 225 is input to the drive unit 226.

The drive unit 226 generates drive information corresponding to each leg for moving each leg according to the track information of each leg of the robot generated by the track generation unit 225 and drives each leg.

Note that the drive information generated by the drive unit 226 includes drive information of the joint of the each leg and drive information of the wheel of each leg.

Note that there is a plurality of driving methods for driving the joints of the robot.

As specific joint driving methods, there are two types of force control type joint driving and position control type joint driving.

In a case where the drive unit 226 is a drive unit that performs force control type joint drive, the drive unit 226 calculates joint torque necessary for achieving the track on the basis of the track information of each leg of the robot generated by the track generation unit 225, and outputs a control signal according to the calculated joint torque to the joint part 231 to drive the joint part.

On the other hand, in a case where the drive unit 226 is a drive unit that performs position control type joint drive, the drive unit 226 calculates both the joint torque and the joint position and the speed necessary for achieving the track on the basis of the track information of each leg of the robot generated by the track generation unit 225, and outputs a control signal according to the calculated joint torque and the joint position and the speed to the joint part 231 to drive the joint part.

Note that the drive unit 226 drives the actuator of the joint part 231 and the wheel part 232 on the basis of the calculation result of the control signal, but in this drive control, a configuration may be adopted in which feedback control using feedback information of the torque sensor of the joint part 231 and the force sensor of the foot tip is performed.

Note that a control cycle of the drive control on the indirect unit 231 and the wheel part 232 by the data processing unit 220 illustrated in FIG. 6 depends on hardware and performance of calculation processing of the CPU.

Furthermore, the processing cycle for the input information from each sensor, that is, the processing cycle of the internal state estimation unit 221 and the external environment estimation unit 222 in the data processing unit 220 illustrated in FIG. 6 may be different.

For example, since the three-dimensional sensor included in the environment sensor 202 and the external environment estimation unit 222 handle a large amount of data, the processing is performed in a cycle of the order of 10 to 100 ms.

On the other hand, the IMU and the encoder included in the state sensor 201 can acquire information at an earlier control cycle, and the internal state estimation unit 221 can perform processing with a different cycle setting so as to perform processing at a cycle earlier than 1 ms.

### 3. Details of Processing Performed by Target Gait Generation Unit, Movable Range Determination Unit, and Track Generation Unit

Next, details of processing performed by the target gait generation unit, the movable range determination unit, and the track generation unit will be described.

Hereinafter, details of processing performed by the target gait generation unit 223, the movable range determination unit 224, and the track generation unit 225 configured in the data processing unit 220 of the moving apparatus 200 described above with reference to FIG. 6 and the like will be described.

As described above with reference to FIG. 6 and the like, the target gait generation unit 223 generates target gait data, that is, target motion sequence data of the robot on the basis of the moving speed information 215 and the predefined target gait parameter defined in advance. Specifically, a target track such as a leg tip position, a trunk position, and a posture of the target is determined.

The movable range determination unit 224 corrects the “target gait” input from the target gait generation unit 223, that is, the “target gait (target track such as a leg tip position, a trunk position, and posture of the target)” input so that the robot can move at the target speed, and determines the movable range of the wheel at the tip end of each leg of the robot.

Each of the following pieces of information is input to the movable range determination unit 224.
(a) Internal state information such as the current position and posture of the trunk of the robot, the position of the center of gravity, the speed, the position of each leg, the speed, and the acceleration from the internal state estimation unit 221
(b) Environment information such as three-dimensional map data generated by the external environment estimation unit 222
(c) Target gait indicating the target track such as a leg tip position, a body trunk position, and a posture of the target (target track such as a leg tip position, a trunk position, and posture of the target) generated by the target gait generation unit 223

The movable range determination unit 224 uses these pieces of input information (a) to (c) to correct the “target gait (target track such as a leg tip position, a trunk position, and posture of the target)” input so that the robot can move at the target speed, and determines the movable range of the wheel at the tip end of each leg of the robot.

The movable range information of the wheel at the tip end of each leg of the robot determined by the movable range determination unit 224 is input to the track generation unit 225.

The track generation unit 225 refers to the movable range of the wheel of the tip end of each leg of the robot determined by the movable range determination unit 224, and generates a track of each leg that satisfies the condition that the wheel of the tip end of each leg is set within the movable range and that enables smooth movement according to a predefined moving speed, that is, the speed of the “moving speed information 215” illustrated in FIG. 6.

Details of processing performed by the target gait generation unit 223, the movable range determination unit 224, and the track generation unit 225 will be described using specific examples.

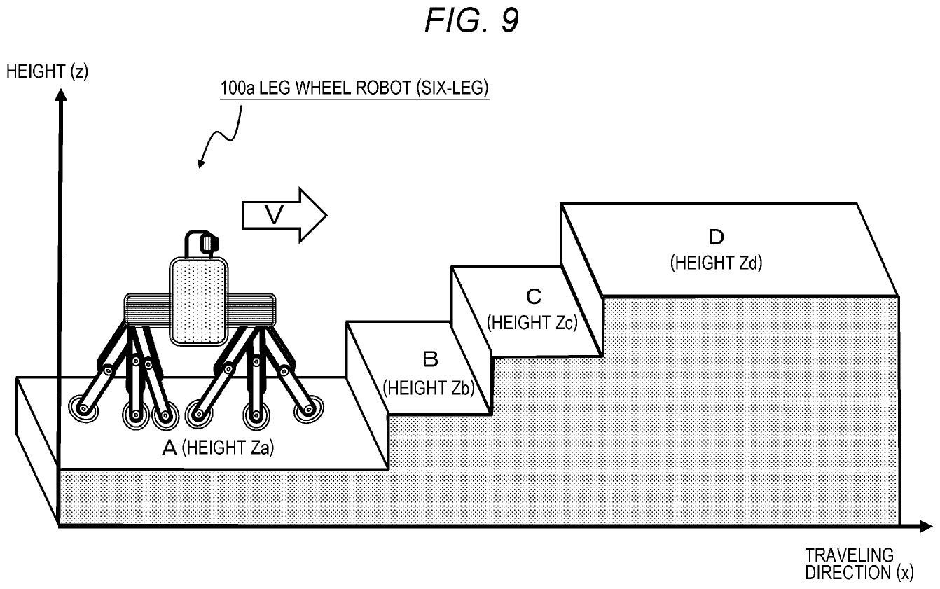

As illustrated in FIG. 9, it is assumed that the six-leg type leg wheel robot 100a goes up stairs.

The height of the stairs increases in the order of the stair surfaces A, B, C, and D, and A has a height Za, B has a height Zb, C has a height Zc, and D has a height Zd.

The leg wheel robot 100a goes up the stairs in the order of the stair surfaces A to D and travels in the x direction.

It is assumed that the data processing unit of the leg wheel robot 100a has received an input of, as the moving speed, that is, the moving speed information 215 illustrated in FIG. 6,
speed=V.

That is, the leg wheel robot 100a is scheduled to travel at a constant speed of the target speed=V toward the x direction illustrated in FIG. 9.

As described above, the target gait generation unit 223 generates target gait data, that is, target motion sequence data of the robot on the basis of the predefined moving speed information 215 and the predefined target gait parameter. Specifically, the target track such as the leg tip position, the trunk position, and the posture of the target is determined as the “target gait”, that is, the target motion sequence.

In the example illustrated in FIG. 9, the predefined moving speed information 215 is target speed=V.

Furthermore, the target gait parameter is a predefined target gait parameter as illustrated in FIG. 7, that is, a parameter of setting in which the free leg period and the grounding period of the three legs are alternately changed.

The target gait generation unit 223 generates target gait data, that is, target motion sequence data of the robot on the basis of the target speed=V and the target gait parameter illustrated in FIG. 7. Specifically, the target track such as the leg tip position, the trunk position, and the posture of the target is determined as the “target gait”, that is, the target motion sequence.

The target gait generation unit 223 calculates a track of a future position of the leg tip in a case where ideal traveling according to the target speed=V and the target gait parameter illustrated in FIG. 7 is performed.

That is, the movement range of each leg in the grounding period is discretely extracted on the assumption that the uniform motion is performed at the speed=V while alternately changing the free leg period and the grounding period by the number of stable minimum support legs (three legs in this example).

As described above with reference to FIG. 7, in a case of the six-legged robot, it is possible to move while always ensuring the three-point grounding by walking while alternately changing the free leg period and the grounding period by the combination of
(p) three legs of the front left leg (FL), the front right leg (FR), and the rear right leg (RR) and
(q) three legs of the front middle leg (FM), the rear right leg (RL), and the rear middle leg (RM).

As described above, the target gait generation unit 223 generates the target gait data, that is, the target motion sequence data of the robot on the assumption that the robot performs the uniform motion at the speed=V while alternately changing the free leg period and the grounding period by the minimum number of support legs (three legs). Specifically, the target track such as the leg tip position, the trunk position, and the posture of the target is determined as the “target gait”, that is, the target motion sequence. In the target gait calculation processing, the movement range of each leg in the grounding period is calculated.

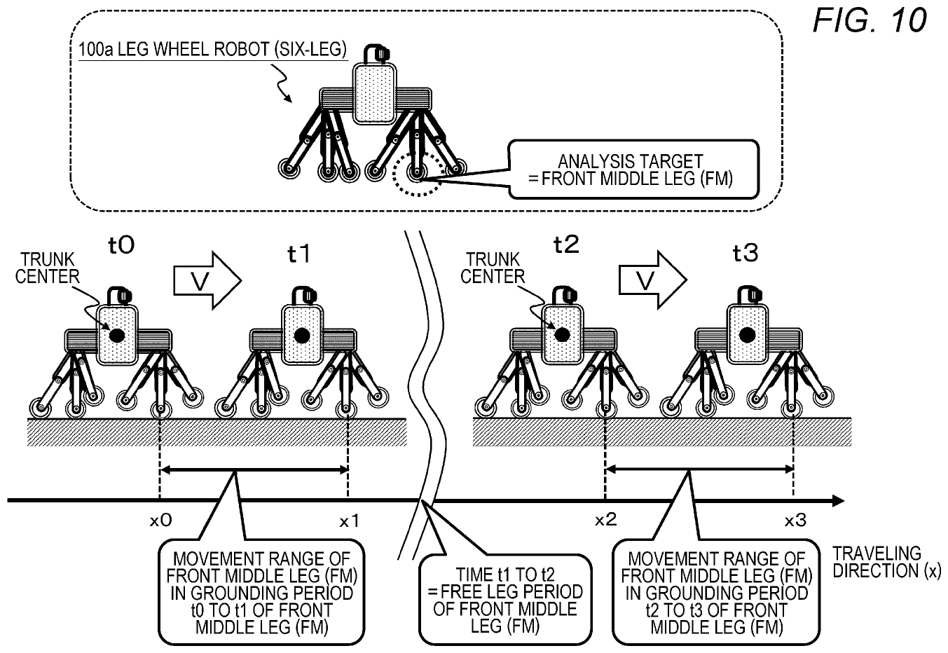

A specific example of the calculation processing of the movement range in the grounding period of each leg performed in the “target gait” generation processing performed by the target gait generation unit 223 will be described with reference to FIG. 10 and subsequent drawings.

As described above, the target gait generation unit 223 calculates the movement range of each leg in the grounding period on the assumption that the uniform motion is performed at the speed=V while alternately changing the free leg period and the grounding period by the number of stable minimum support legs (three legs).

In a case of the six-leg type leg wheel robot 100a, the target gait generation unit 223 calculates the movement range of each leg in the grounding period for each of the six legs.

A processing example in a case where the front middle leg (FM) of the six-leg type leg wheel robot 100a is to be analyzed, that is, a calculation processing example of the movement range of the front middle leg (FM) in the grounding period will be described with reference to FIG. 10 and subsequent drawings.

FIG. 10 illustrates a state at each of the following times of the traveling mode of the six-leg type leg wheel robot 100a described above with reference to FIG. 8.
time t0 to t1
time t2 to t3

Note that, in FIG. 10, a period between times t1 and t2 is omitted.

Two periods of time t0 to t1 and time t2 to t3 illustrated in FIG. 10 correspond to a period in which the front middle leg (FM) of the six-leg type leg wheel robot 100a to be analyzed is in the grounding period.

That is, as described above with reference to FIG. 8,
time t01 to t1 and time t2 to t3 are times corresponding to the time=0.1 to 0.5 illustrated in FIG. 7. In the setting of the gait parameter in FIG. 7 of the times,
three legs of a front left leg (FL), a front right leg (FR), and a rear right leg (RR) are in the free leg period, and
three legs of the front middle leg (FM), the rear right leg (RL), and the rear middle leg (RM) are in the grounding period.

That is, the front middle leg (FM) to be analyzed corresponds to the period of the grounding period.

The target gait generation unit 223 calculates the movement range of the front middle leg (FM) in the grounding period on the assumption that the six-leg type leg wheel robot 100a performs a uniform motion at speed=V.

As illustrated in FIG. 10, when the six-leg type leg wheel robot 100a performs a uniform motion at speed=V in the grounding period from time t0 to t1, the movement range of the front middle leg (FM) is x0 to x1.

Furthermore, when the six-leg type leg wheel robot 100a performs a uniform motion at speed=V in the grounding period from time t2 to t3, the movement range of the front middle leg (FM) is x2 to x3.

Note that the movement range is calculated on the assumption that the front middle leg (FM) to be analyzed extends vertically downward with respect to the robot.

Note that the length (distance) of the movement range x0 to x1 in the grounding period t0 to t1 of the front middle leg (FM) is equal to the length (distance) of the movement range x2 to x3 in the grounding period t2 to t3.

This is because it is assumed that the leg wheel robot 100a performs a uniform motion at the speed=V.

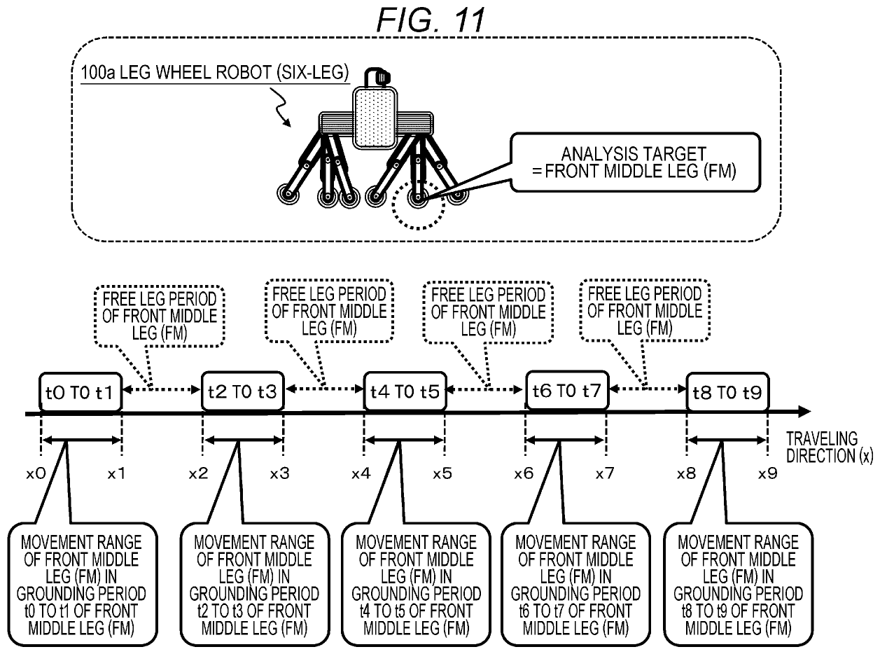

FIG. 11 is a diagram illustrating analysis data after time t3 in addition to the data illustrated in FIG. 10.

As illustrated in FIG. 11, the grounding period of the front middle leg (FM) includes each of the periods of
time=t0 to t1, t2 to t3, t4 to t5, t6 to t7, t8 to t9.
Times of
time=t1 to t2, t3 to t4, t5 to t6, t7 to 8
are the free leg period of the front middle leg (FM).

The front middle leg (FM) moves on the travel surface by rotating the wheel of the leg tip at each of times of
time=t0 to t1, t2 to t3, t4 to t5, t6 to t7, t8 to t9.
that are the grounding period.

A range in which the front middle leg (FM) moves in each grounding period is as follows as illustrated in FIG. 11.
Movement range of time t0 to t1=x0 to x1
Movement range of time t2 to t3=x2 to x3
Movement range of time t4 to t5=x4 to x5
Movement range of time t6 to t7=x6 to x7
Movement range of time t8 to t9=x8 to x9

Note that, since it is assumed that the leg wheel robot 100a performs the uniform motion at the speed=V, the lengths (moving distances) of the movement ranges at the times described above are all the same.

As described above, assuming that the leg wheel robot 100a performs a uniform motion with the moving speed information 215 described with reference to FIG. 6, that is, at the speed=V, the target gait generation unit 223 calculates the target movement range of each leg in the grounding period, and generates the “target gait” including the target movement range of each leg.

The “target gait” including the target movement range in the grounding period of each leg calculated by the target gait generation unit 223 is input to the movable range determination unit 224.

The movable range determination unit 224 corrects the “target gait” input from the target gait generation unit 223, that is, the target movement range in the grounding period of each leg for moving the robot at the target speed in consideration of the actual travel surface. That is, the corrected movement range corresponding to the actual travel surface is generated.

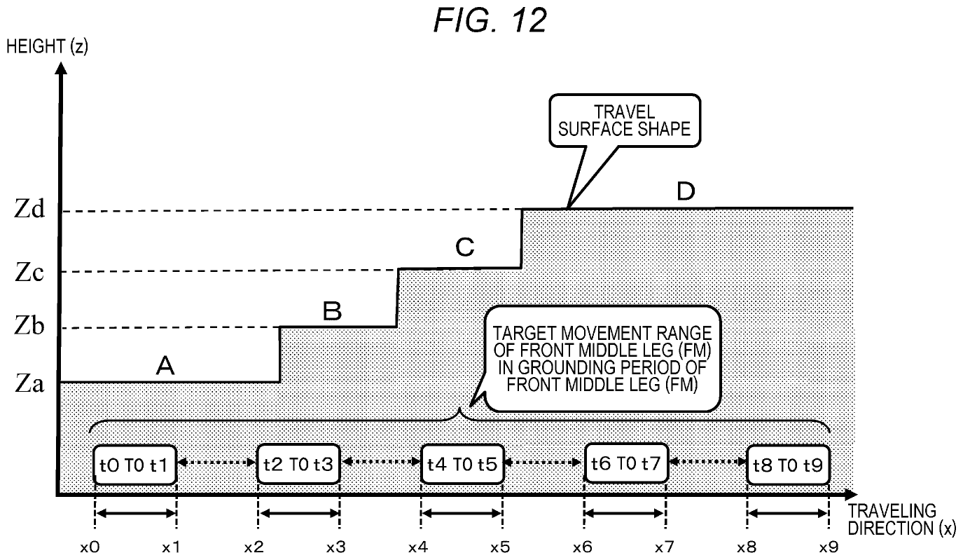

A specific example of processing performed by the movable range determination unit 224 with reference to FIG. 12 and subsequent drawings.

Each of the following pieces of information is input to the movable range determination unit 224.
(a) Internal state information such as the current position and posture of the trunk of the robot, the position of the center of gravity, the speed, the position of each leg, the speed, and the acceleration from the internal state estimation unit 221
(b) Environment information such as three-dimensional map data generated by the external environment estimation unit 222
(c) Target gait indicating the target track such as a leg tip position, a body trunk position, and a posture of the target (target track such as a leg tip position, a trunk position, and posture of the target) generated by the target gait generation unit 223

The “target gait” input from the target gait generation unit 223 of (c) described above includes the movement range information to be the target in the grounding period of each leg described above with reference to FIGS. 10 and 11.

The movable range determination unit 224 corrects the target movement range of each leg in the grounding period input from the target gait generation unit 223 in consideration of the actual travel surface, and generates a corrected movement range of each leg corresponding to the actual travel surface.

FIG. 12 is a diagram illustrating a travel surface shape of the robot generated from the environment information such as the three-dimensional map data input from the external environment estimation unit 222 by the movable range determination unit 224, and
target movement range information in the grounding period of the leg (front middle leg (FM)) input from the target gait generation unit 223 by the movable range determination unit 224.

The travel surface shape is the stairs-like shape described above with reference to FIG. 9.

The target movement range of the front middle leg (FM) in the grounding period is the data described above with reference to FIG. 11. That is, the following movement ranges are illustrated as the target movement ranges during the grounding period of the front middle leg (FM) in a case where the six-leg type leg wheel robot 100a moves at the speed=V.
Movement range of time t0 to t1=x0 to x1
Movement range of time t2 to t3=x2 to x3
Movement range of time t4 to t5=x4 to x5
Movement range of time t6 to t7=x6 to x7
Movement range of time t8 to t9=x8 to x9

The movement range in each period is a target movement range in a case where it is assumed that the six-leg type leg wheel robot 100a is caused to travel at speed=V and the six-leg type leg wheel robot 100a travels with the gait parameters described above with reference to FIG. 7, that is, by switching the free leg period and the grounding period for every three legs.

That is, if the movement range in which traveling is performed by rotating the wheels with the front middle leg (FM) grounded to the travel surface is set as indicated in the target movement range illustrated in FIG. 12, the stable traveling at the speed=V can be performed.

However, whether or not the robot can travel with the leg grounded as indicated in the target movement range illustrated in FIG. 12 depends on the shape of the travel surface on which the robot travels.

For example, when all the travel surfaces are flat surfaces, traveling with the leg grounded as indicated in the target movement range illustrated in FIG. 12 can be performed.

However, in a case of the travel surface being stairs as illustrated in FIG. 12, the traveling with the leg grounded as indicated in the target movement range illustrated in FIG. 12 cannot be performed.

Note that the travel surface shape illustrated in FIG. 12 is the stairs-like shape described above with reference to FIG. 9.

As described above with reference to FIG. 9, the height of the stairs increases in the order of the stair surfaces A, B, C, and D, and A has a height Za, B has a height Zb, C has a height Zc, and D has a height Zd.

The leg wheel robot 100a goes up the stairs in the order of the stair surfaces A to D and travels in the x direction.

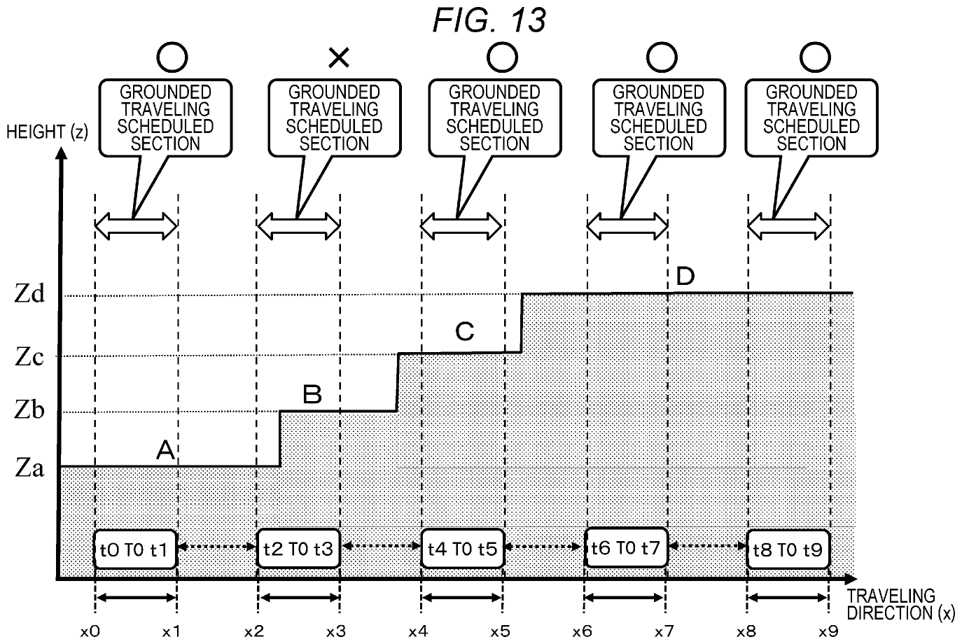

The reason why the traveling with the leg grounded as indicated in the target movement range illustrated in FIG. 12 cannot be performed in a case of the travel surface being stairs as illustrated in FIG. 12 will be described with reference to FIG. 13.

FIG. 13 illustrates a correspondence relationship between the target movement range of each grounding period of the front middle leg (FM), that is,
Movement range of time t0 to t1=x0 to x1
Movement range of time t2 to t3=x2 to x3
Movement range of time t4 to t5=x4 to x5
Movement range of time t6 to t7=x6 to x7
Movement range of time t8 to t9=x8 to x9
and the stair shape, and further, a grounded traveling planned section corresponding to each target movement range and whether or not grounded traveling of each section is possible.

Since the entire range of the movement range=x0 to x1 from time t0 to t1 is included on one stair surface A, traveling by rotating the wheels with the front and middle legs (FM) grounded to the travel surface (A surface) for the entire section of the range=x0 to x1 can be performed.

However, the movement range=x2 to x3 in time t2 to t3 is included on the stair surfaces having two different heights of the stair surface A and the stair surface B.

Therefore, traveling by rotating the wheel with the front middle leg (FM) grounded to the travel surface cannot be performed in the entire section of this range=x2 to x3.

Since the entire range of the movement range=x4 to x5 of time t4 to t5 is included on one stair surface C, traveling by rotating the wheels with the front and middle legs (FM) grounded to the travel surface (C surface) for the entire section of the range=x4 to x5 can be performed.

Since the entire range of the movement range=x6 to x7 of time t6 to t7 is included on one stair surface D, traveling by rotating the wheels with the front and middle legs (FM) grounded to the travel surface (D surface) for the entire section of the range=x6 to x7 can be performed.

Since the entire range of the movement range=x8 to x9 of time t8 to t9 is included on one stair surface D, traveling by rotating the wheels with the front and middle legs (FM) grounded to the travel surface (D surface) for the entire section of the range=x8 to x9 can be performed.

As described above, the movable range determination unit 224 decides whether or not the grounded traveling can be performed in the grounded traveling scheduled section corresponding to the target movement range of each leg of the robot included in the “target gait” input from the target gait generation unit 223.

In the example illustrated in FIG. 13, as the decision result,
the movable range determination unit 224 decides that the target movement range=x2 to x3 of time t2 to t3 is included on the stair surfaces having two different heights of the stair surface A and the stair surface B, and continuous grounded traveling cannot be performed. The movable range determination unit 224 decides that all the target movement ranges in the other grounding periods belong to one stair surface and the continuous grounded traveling is possible.

Moreover, the movable range determination unit 224 corrects the target movement range in which it is decided that the continuous grounded traveling in the grounding period cannot be performed.

In this example, the movable range determination unit 224 corrects the target movement range=x2 to x3 of time t2 to t3 at which it is decided that the continuous grounded traveling cannot be performed, and generates the corrected movement range of time t2 to t3.

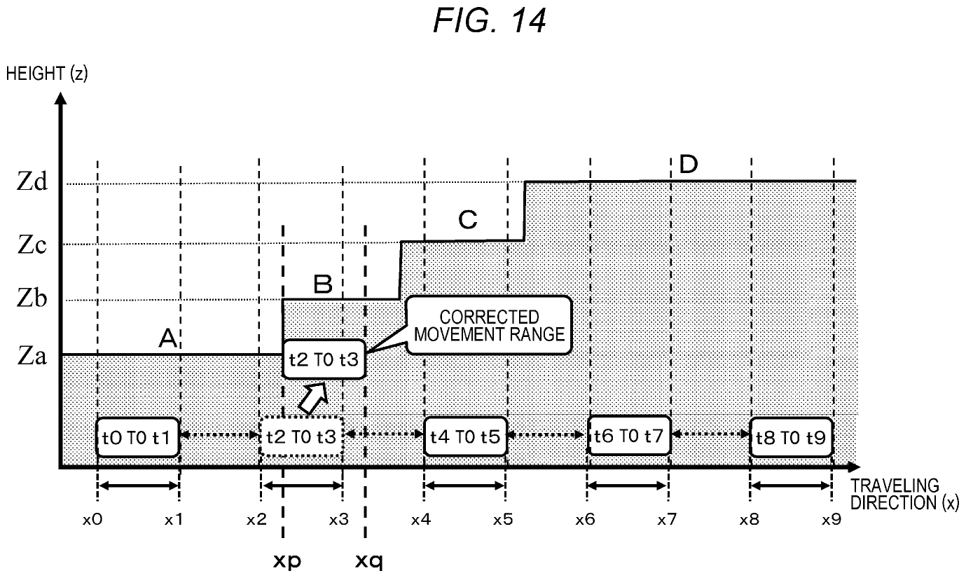

A specific example of corrected movement range generation processing performed by the movable range determination unit 224 will be described with reference to FIG. 14.

FIG. 14 illustrates an example in which
the movable range determination unit 224 corrects the target movement range=x2 to x3 of time t2 to t3 at which it is decided that the continuous grounded traveling cannot be performed, and
generates the corrected movement range=xp to xq of time t2 to t3.

In the corrected movement range=xp to xq, all the movement ranges are set to belong to one stair surface B.

The target movement range=x2 to x3 of time t2 to t3 generated on the basis of the target speed=V before correction is included on the stair surfaces having two different heights of the stair surface A and the stair surface B, and continuous grounded traveling cannot be performed.

In a case where the target movement range of the grounding time generated on the basis of the target speed=V as described above is in a range in which the continuous grounded traveling is not possible, the movable range determination unit 224 analyzes a stair surface included in the target movement range, selects a stair surface including a large number of target movement ranges, and sets a corrected movement range on the selected stair surface.

In the example illustrated in FIG. 14, the target movement range=x2 to x3 of time t2 to t3 generated on the basis of the target speed=V is included on the stair surfaces having two different heights of the stair surface A and the stair surface B, and about 80% of the target movement range x2 to x3 is included in the stair surface B.

On the basis of this result, the movable range determination unit 224 selects the stair surface B and sets the corrected movement ranges xp to xq in the selected stair surface B.

Note that, in principle, the distance of the corrected movement ranges xp to xq is the same as the distance of the target movement range=x2 to x3 of times t2 to t3 generated on the basis of the target speed=V.

However, in a case where a corrected movement range having the same distance as the distance of the target movement range=x2 to x3 cannot be secured in one selected stair surface, the distance of the corrected movement range is set to be smaller than the distance of the target movement range.

Note that control is basically performed such that the robot moves according to the target speed=V as the movement speed.

Therefore, for example, in the example illustrated in FIG. 14, in a case where the target movement range=x2 to x3 of time t2 to t3 is changed to the corrected movement range=xp to xq, the position reached at time t3 is changed from x3 to xq, and the local movement speed is changed. The track generation unit 225 of the data processing unit 220 illustrated in FIG. 6 adjusts the local speed change to perform the adjustment processing of bringing the speed average of the entire traveling path close to the target speed=V. Details of this will be described later.

Note that, as illustrated in FIG. 14, in a case where the corrected movement ranges xp to xq on the stair surface B are set by correcting the target movement ranges=x2 to x3 of time t2 to t3 generated on the basis of the target speed=V, it is necessary to raise the legs of the robot, that is, the front middle leg (FM) in this example, on the stair surface B at the stage of time t2.

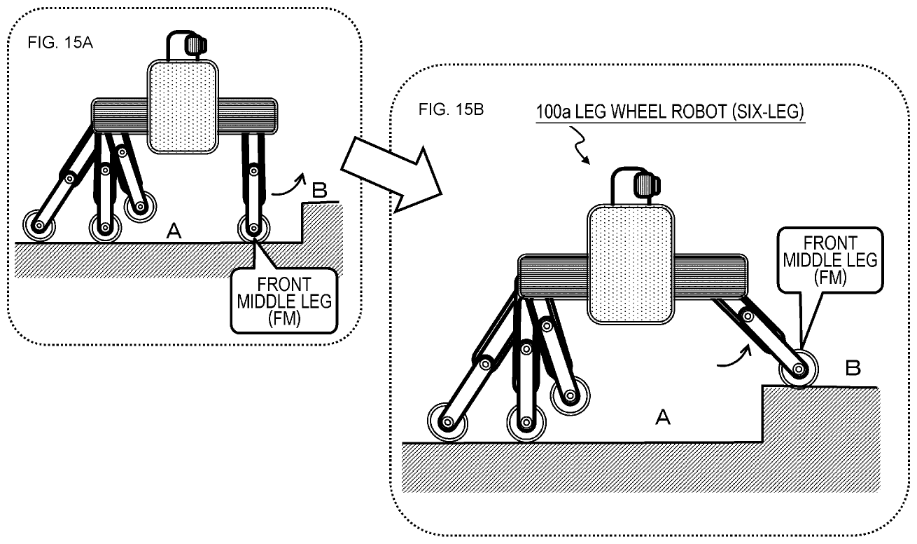

FIG. 15 illustrates a specific control example of the front middle leg (FM) in the case of achieving such movement.

FIG. 15 is a diagram illustrating a specific example of movement of a front middle leg (FM) of the leg wheel robot 100a at a timing of time t2.

As illustrated in FIGS. 15(a) to (b), at the timing of time t2, the wheel at the leg tip of the front middle leg (FM) of the leg wheel robot 100a is swung up to the height of the stair surface B and placed on the stair surface B, and then the grounded traveling is started.

Note that the swing up processing of the front middle leg (FM) is performed by the control of the rotary joint 103 and the linear motion joint 104.

Note that the track generation processing of determining the motion of the leg is performed in the track generation unit 225, and the actual leg drive processing is performed by the drive unit 225 according to the track generated by the track generation unit 225.

As described above with reference to FIGS. 13 and 14, the movable range determination unit 224 corrects the target movement range in which it is decided that the continuous grounded traveling of each leg in the grounding period cannot be performed.

That is, as described above with reference to FIG. 14, the movable range determination unit 224 corrects the target movement range=x2 to x3 of time t2 to t3 at which it is decided that the continuous grounded traveling cannot be performed, and generates the corrected movement range xp to xq.

Moreover, in a case where the continuous grounded traveling in the grounding period of each leg is possible, and a plurality of separated target movement ranges in a plurality of different grounding periods belongs to one stair surface or the like, the movable range determination unit 224 may perform processing of setting the plurality of separated target movement ranges as a corrected movement range corresponding to one grounding period by connecting the plurality of separated target movement ranges.

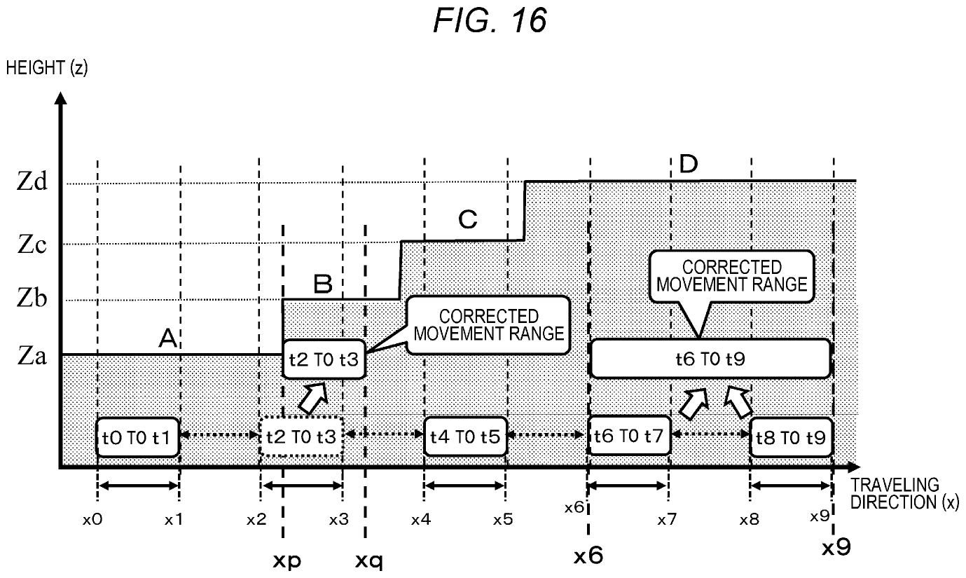

A specific example of this will be described with reference to FIG. 16.

As illustrated in FIG. 16, two target movement ranges, that is,
the target movement range of time t6 to t7=x6 to x7, and
the target movement range of time t8 to t9=x8 to x9
generated on the basis of the target speed=V are all included in one stair surface D.

These two target movement ranges (x6 to x7, x8 to x9) are two target movement ranges corresponding to two adjacent grounding periods (t6 to t7, t8 to t9) of the front middle leg (FM) in a case where it is assumed that the six-leg type leg wheel robot 100a travels while switching the grounding period and the free leg period by three legs in accordance with the target gait parameters described above with reference to FIG. 7.

The period from time t7 to t8 originally corresponds to a free leg period of the front middle leg (FM), and is a period in which it is not necessary to ground the front middle leg (FM). That is, in the target gait data generated by the target gait generation unit 223 according to the target gait parameter described with reference to FIG. 7, time t7 to t8 is set as a period in which the front middle leg (FM) is a free leg period and the leg is not grounded.

However, as illustrated in FIG. 16, two target movement ranges of
the target movement range of time t6 to t7=x6 to x7, and
the target movement range of time t8 to t9=x8 to x9
are both included in one stair surface D, and continuous travel with the front middle leg (FM) grounded on the stair surface D can be performed in the entire period of time t6 to t9.

In a case where a plurality of target movement ranges set to enable continuous grounded traveling is detected as described above, the movable range determination unit 224 sets the plurality of target movement ranges as one corrected movement range and sets the entire range of the corrected movement range as a range for grounded traveling as illustrated in FIG. 16.

Note that even if the free leg period is changed to the grounding period, the stability of the robot is not reduced, and more stable traveling can be performed. Thus, the correction processing of increasing the grounding period of the leg is effective for making the robot travel more stably.

As described above, in a case where the continuous grounded traveling in the grounding period of each leg is possible, and a plurality of separated target movement ranges in a plurality of different grounding periods belongs to one stair surface or the like, the movable range determination unit 224 may perform processing of setting the plurality of separated target movement ranges as a corrected movement range corresponding to one grounding period by connecting the plurality of separated target movement ranges.

As described with reference to FIGS. 13 to 16, the movable range determination unit 224 finally performs the following two types of corrected movement range setting processing.
(Correction 1) A target movement range in which it is decided that the continuous grounded traveling cannot be performed is corrected to generate a corrected movement range in which the continuous grounded traveling is possible.
(Correction 2) A corrected movement range in which one continuous grounded traveling is possible is generated by connecting a plurality of separated target movement ranges.

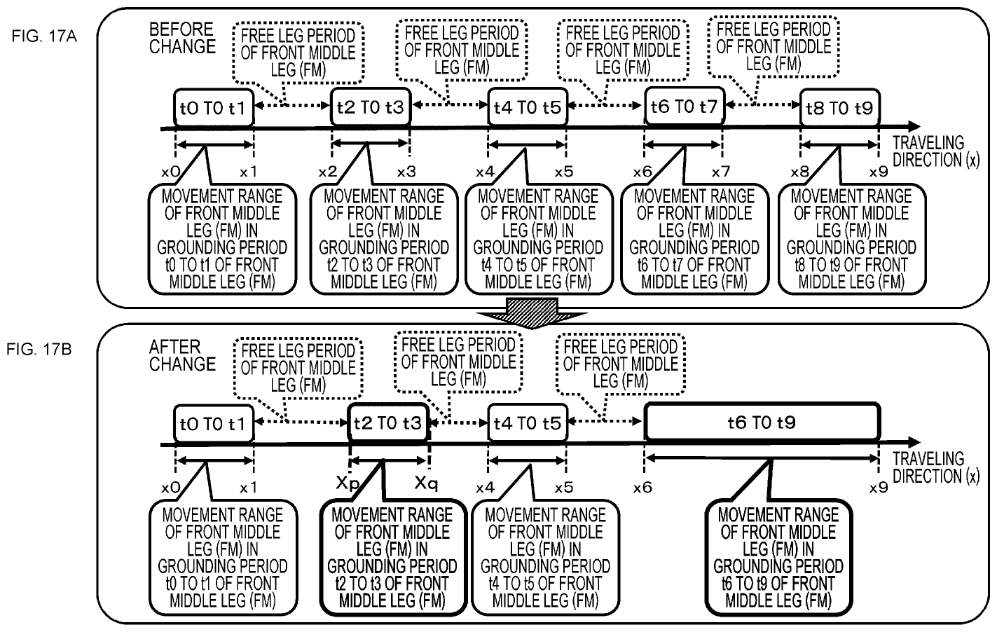

FIG. 17 is a diagram describing a difference in movement range setting before and after correction of the target movement range by the movable range determination unit 224.
(a) is a target movement range of the grounding period of the front middle leg (FM) before correction of the target movement range by the movable range determination unit 224.
(b) is a movement range of the grounding period of the front middle leg (FM) after correction of the target movement range by the movable range determination unit 224.
(a) is the target movement ranges during the grounding period of the front middle leg (FM) in a case where the six-leg type leg wheel robot 100a moves at the speed=V, and indicates the following movement ranges.
Movement range of time t0 to t1=x0 to x1
Movement range of time t2 to t3=x2 to x3
Movement range of time t4 to t5=x4 to x5
Movement range of time t6 to t7=x6 to x7
Movement range of time t8 to t9=x8 to x9

The movement range in each period is a target movement range in a case where it is assumed that the six-leg type leg wheel robot 100a is caused to travel at speed=V and the six-leg type leg wheel robot 100a travels with the gait parameters described above with reference to FIG. 7, that is, by switching the free leg period and the grounding period for every three legs.

That is, if the movement range in which traveling is performed by rotating the wheels with the front middle leg (FM) grounded to the travel surface is set as indicated in the target movement range illustrated in FIG. 12, the stable traveling at the speed=V can be performed.

On the other hand, (b) is the movement range of the grounding period of the front middle leg (FM) after the correction of the target movement range by the movable range determination unit 224, and is a result of performing the following two types of movement range correction processing as described above.
(Correction 1) A target movement range in which it is decided that the continuous grounded traveling cannot be performed is corrected to generate a corrected movement range in which the continuous grounded traveling is possible.
(Correction 2) A corrected movement range in which one continuous grounded traveling is possible is generated by connecting a plurality of separated target movement ranges.

In the example illustrated in FIG. 17, the correction data corresponding to (correction 1) described above is
data obtained by correcting the target movement range=x2 to x3 at time t2 to t3 illustrated in FIG. 17(a) to the corrected movement range=xp to xq at time t2 to t3 illustrated in FIG. 17(b).

Furthermore, the correction data corresponding to the (correction 2) described above is
data obtained by correcting the target movement range=x6 to x7 at time t6 to t7 and the target movement range=x8 to x9 at time t8 to t9 illustrated in FIG. 17(a) to the corrected movement range=x6 to x9 at time t6 to t9 illustrated in FIG. 17(b).

As described above, the movable range determination unit 224 corrects the target movement range of each leg in the grounding period input from the target gait generation unit 223 in consideration of the actual travel surface, and generates a corrected movement range of each leg corresponding to the actual travel surface.

Note that, as the processing described with reference to FIGS. 10 to 17 described above, an example of the processing performed by the movable range determination unit 224 on the front middle leg (FM) of the six-leg type leg wheel robot 100a has been described. However, the movable range determination unit 224 performs similar processing on each leg of the robot, and corrects the target movement range in the grounding period of each leg input from the target gait generation unit 223 in consideration of the actual travel surface to generate the corrected movement range of each leg corresponding to the actual travel surface.

The corrected movement range of each leg generated by the movable range determination unit 224 is input to the track generation unit 225 illustrated in FIG. 6.

The track generation unit 225 refers to the movable range of the wheel of the tip end of each leg of the robot determined by the movable range determination unit 224, and generates a track of each leg that satisfies the condition that the wheel of the tip end of each leg is set within the movable range and that enables smooth movement according to the predefined target speed=V, that is, the speed of the “moving speed information 215” illustrated in FIG. 6.

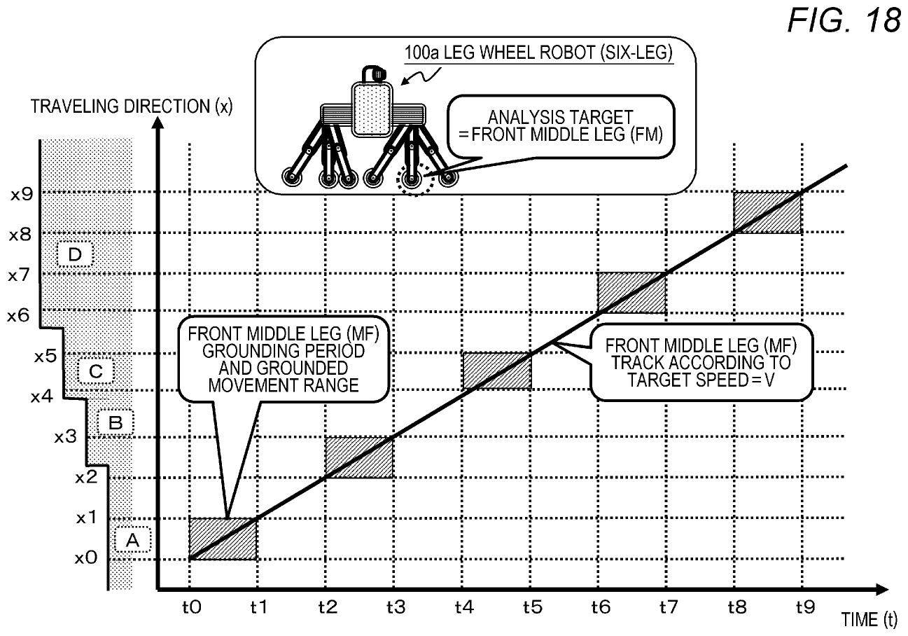

A specific example of leg track generation processing performed by the track generation unit 225 will be described with reference to FIGS. 18 to 20.

FIGS. 18 to 20 illustrate a processing example of the front middle leg (FM) of the six-leg type leg wheel robot 100a as described above with reference to FIGS. 10 to 17.

That is, the drawings describes a specific example of the leg track generation processing of the front middle leg (FM) of the six-leg type leg wheel robot 100a performed by the track generation unit 225.

The graph illustrated in FIG. 18 is a graph in which the horizontal axis represents time (t) and the vertical axis represents the position of the six-leg type leg wheel robot 100a in the traveling direction (x).

On the left side of the vertical axis (traveling direction (x)), the positions of the stairs A to D corresponding to the traveling position x are illustrated.
t1 to t9 indicated on the time axis (horizontal axis) are times similar to times t1 to t9 described with reference to FIGS. 11 to 17, and x1 to x9 indicated on the vertical axis (traveling direction (x)) are positions similar to the positions x1 to x9 described with reference to FIGS. 11 to 17.

A straight line “the front middle leg (MF) track according to the target speed=V” illustrated in the graph of FIG. 18 is a straight line indicating the traveling position (x) corresponding to the time (t) of the front middle leg (FM) traveling in a case where the robot travels according to the target speed=V.

That is, “the front middle leg (MF) track according to the target speed=V” illustrated in FIG. 18 is a straight line indicating the traveling position (x) corresponding to the time (t) of the front middle leg (FM) in a case where the robot moves according to the target speed=V corresponding to the moving speed information 215 illustrated in FIG. 6.

The inclination of the straight line corresponds to the speed V (=(Δx/Δt)).

However, the straight line illustrated in FIG. 18 is a straight line at the speed V indicating the ideal traveling position (x) corresponding to the time (t) of the front middle leg (FM) in a case where the robot travels according to the target speed=V described above with reference to FIG. 13.

The straight line of the graph illustrated in FIG. 18 is a straight line in a case where the front middle leg (FM) is set to travel in each target movement range of each grounding time as below in a case where the robot travels according to the target speed=V and the target parameter described with reference to FIG. 7.
Target movement range of time t0 to t1=x0 to x1
Target movement range of time t2 to t3=x2 to x3
Target movement range of time t4 to t5=x4 to x5
Target movement range of time t6 to t7=x6 to x7
Target movement range of time t8 to t9=x8 to x9

The straight line illustrated in the graph of FIG. 18 has such a correspondence relationship between the time and the target movement range, and is data similar to the data described above with reference to FIG. 13.

Note that a rectangular hatched portion in the graph corresponds to the grounding period and the grounding movement range of the front middle leg (FM).

However, as described above with reference to FIGS. 13 to 17, for example, the target movement range x2 to x3 of time t2 to t3 includes the two stair surfaces of the stair surface A and the stair surface B, and thus, the robot cannot travel along the straight line illustrated in FIG. 18, that is, the robot cannot travel according to the target speed=V and the target parameters described with reference to FIG. 7.

Therefore, the movable range determination unit 224 corrects the movement range of the grounding period as described above. Specifically, the following two types of corrected movement range setting processing are performed.
(Correction 1) A target movement range in which it is decided that the continuous grounded traveling cannot be performed is corrected to generate a corrected movement range in which the continuous grounded traveling is possible.
(Correction 2) A corrected movement range in which one continuous grounded traveling is possible is generated by connecting a plurality of separated target movement ranges.

That is, as described above with reference to FIG. 17, the movable range determination unit 224 performs (Correction 1) and (Correction 2) described above to generate the corrected movement range in which the grounded traveling in the grounding period is possible.

The track generation unit 225 inputs the corrected movement range information generated by the movable range determination unit 224, specifically, for example, the movement range information in units of grounding periods corresponding to each leg as illustrated in FIG. 17(B).

First, the track generation unit 225 generates the correspondence relationship data of the time and the positional relationship using the corrected movement range information generated by the movable range determination unit 224.

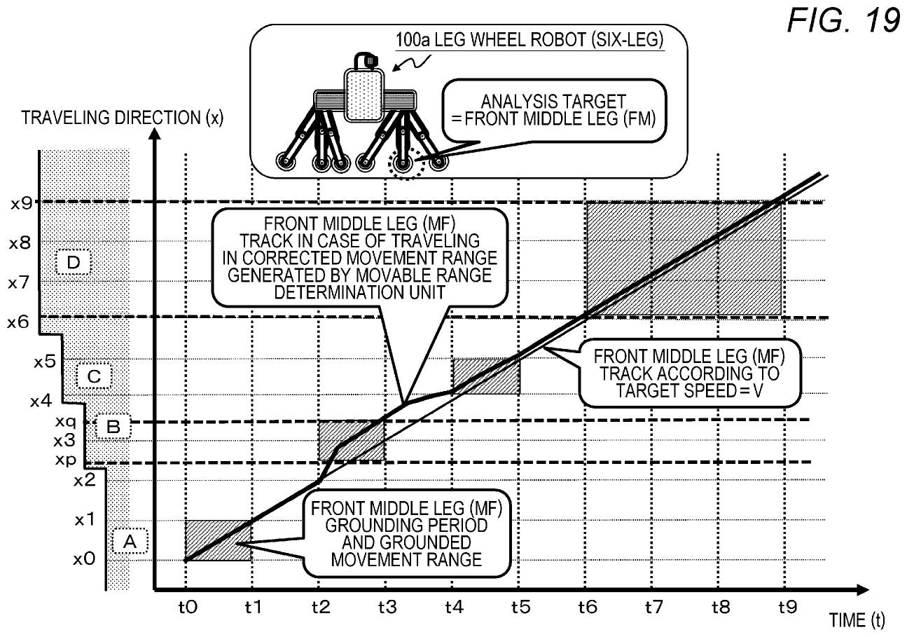

Specifically, the data is, for example, a graph illustrated in FIG. 19.

As similar to FIG. 18 described above, the graph illustrated in FIG. 19 is a graph in which the horizontal axis represents time (t) and the vertical axis represents the position of the six-leg type leg wheel robot 100a in the traveling direction (x).

On the left side of the vertical axis (traveling direction (x)), the positions of the stairs A to D corresponding to the traveling position x are illustrated.
t1 to t9 indicated on the time axis (horizontal axis) are times similar to times t1 to t9 described with reference to FIGS. 11 to 17, and x1 to x9 indicated on the vertical axis (traveling direction (x)) are positions similar to the positions x1 to x9 described with reference to FIGS. 11 to 17.

FIG. 19 illustrates,
in addition to the straight line described with reference to FIG. 18, that is, “the front middle leg (MF) track according to the target speed=V”,
“a front middle leg (MF) track in a case of traveling in the corrected movement range generated by the movable range determination unit”.

The “front middle leg (MF) track in a case of traveling in the corrected movement range generated by the movable range determination unit” is a track reflecting the corrected movement range generated by the movable range determination unit 224.

That is, the front middle leg (MF) track is a track reflecting the corrected movement range in which grounded traveling can be performed in the grounding period, generated by the movable range determination unit 224 by performing (Correction 1) and (Correction 2) as below.
(Correction 1) A target movement range in which it is decided that the continuous grounded traveling cannot be performed is corrected to generate a corrected movement range in which the continuous grounded traveling is possible.
(Correction 2) A corrected movement range in which one continuous grounded traveling is possible is generated by connecting a plurality of separated target movement ranges.

Note that a rectangular hatched portion in the graph corresponds to the grounding period and the grounding movement range of the front middle leg (FM).

However, the “front middle leg (MF) track in a case of traveling in the corrected movement range generated by the movable range determination unit” illustrated in FIG. 19 is data in which only the movement range in each grounding period is corrected, and as a result, there is a possibility that the average speed or the local speed of the robot is set to be different from the target speed=V.

The track generation unit 225 performs track correction to control such a change in speed. For example, the track generation unit 225 corrects the track of each leg, that is, the “front middle leg (MF) track in a case of traveling in the corrected movement range generated by the movable range determination unit” illustrated in FIG. 19 so as to satisfy the principle of the grounded traveling in the corrected movement range generated by the movable range determination unit 224 and follow the target speed=V as much as possible.

As specific track correction processing, for example, track optimization processing is performed using quadratic programming (QP) or the like, which is a representative method of nonlinear programming in mathematical optimization.

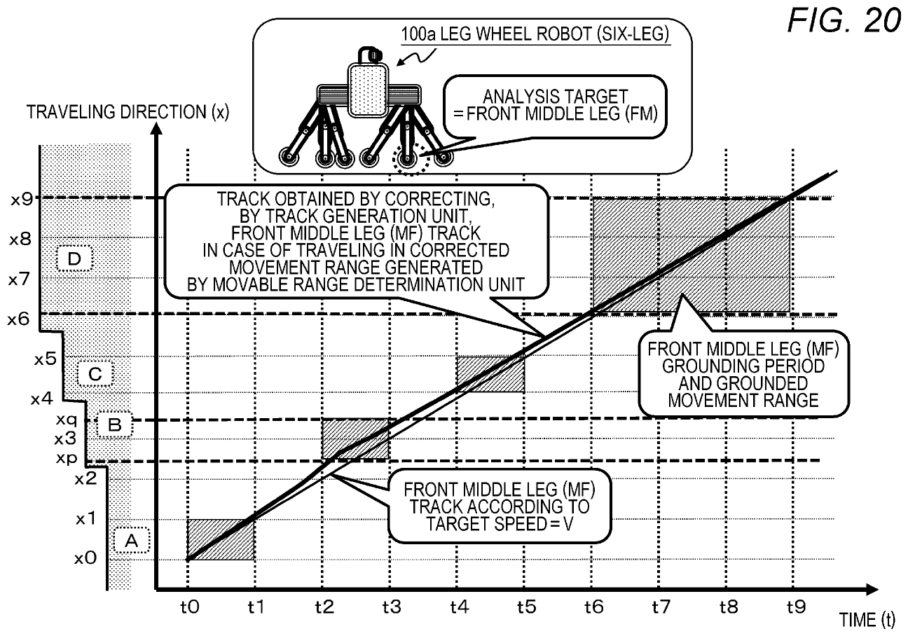

FIG. 20 illustrates an example of the track corrected by this optimization processing. The “track obtained by correcting, by the track generation unit, the front middle leg (MF) track in a case of traveling in the corrected movement range generated by the movable range determination unit” illustrated in FIG. 20 is a track generated by performing optimization processing using quadratic programming (QP) or the like on the “front middle leg (MF) track in a case of traveling in the corrected movement range generated by the movable range determination unit” illustrated in FIG. 19.

As described above, the track generation unit 225 refers to the movable range of the wheel of the tip end of each leg of the robot determined by the movable range determination unit 224, and generates a track of each leg that satisfies the condition that the wheel of the tip end of each leg is set within the movable range and that enables smooth movement according to a predefined moving speed, that is, the speed of the “moving speed information 215” illustrated in FIG. 6.

The track information of each leg of the robot generated by the track generation unit 225 is input to the drive unit 226.

The drive unit 226 generates drive information for driving each leg so that each leg moves according to the track information of each leg of the robot generated by the track generation unit 225.

Note that the drive information generated by the drive unit 226 includes drive information of the joint of the each leg and drive information of the wheel of each leg.

Note that there is a plurality of driving methods for driving the joints of the robot.

As specific joint driving methods, there are two types of force control type joint driving and position control type joint driving.

In a case where the drive unit 226 is a drive unit that performs force control type joint drive, the drive unit 226 calculates joint torque necessary for achieving the track on the basis of the track information of each leg of the robot generated by the track generation unit 225, and outputs a control signal according to the calculated joint torque to the joint part 231 to drive the joint part.

On the other hand, in a case where the drive unit 226 is a drive unit that performs position control type joint drive, the drive unit 226 calculates both the joint torque and the joint position and the speed necessary for achieving the track on the basis of the track information of each leg of the robot generated by the track generation unit 225, and outputs a control signal according to the calculated joint torque and the joint position and the speed to the joint part 231 to drive the joint part.

Note that the drive unit 226 drives the actuator of the joint part 231 and the wheel part 232 on the basis of the calculation result of the control signal, but in this drive control, a configuration may be adopted in which feedback control using feedback information of the torque sensor of the joint part 231 and the force sensor of the foot tip is performed.

As described above, the moving apparatus of the present disclosure achieves stable traveling without substantially stopping according to the predefined moving speed information 215 (target speed=V) by the processing of the target gait generation unit 223, the movable range determination unit 224, the track generation unit 225, and the like in the data processing unit 220 illustrated in FIG. 6.

Specifically, a track of each leg for achieving stable traveling according to the predefined moving speed information 215 (target speed=V) is generated, and each leg is driven according to the generated track, thereby achieving stable traveling according to the moving speed information 215 (target speed=V).

### 4. Other Embodiments

Next, other embodiments will be described.

In the above-described embodiment, embodiments in which the six-leg type leg wheel robot 100a goes up straight stairs has been described, but the configuration and processing of the present disclosure are not limited to the six-leg type, and can be applied to a four-leg type or eight-leg type leg wheel robot.

Furthermore, similar processing can be performed not only in a case of going up the stairs but also in a case of going down the stairs.

Moreover, the present disclosure is applicable not only to a case of the stairs but also to a case of traveling on an uneven traveling road with many irregularities. For example, in a case where there are many uneven surfaces during the grounding period, it is possible to perform processing of moving the grounding region to a region with high flatness while avoiding the region with many irregularities.

Moreover, the processing of the present disclosure is applicable not only to the stairs of a linear shape, and for example, also to a case of going up and down spiral stairs.

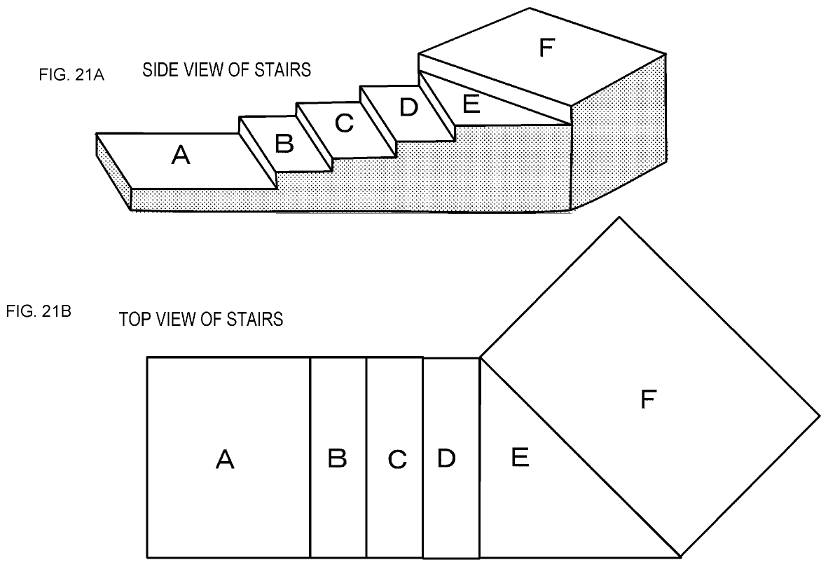

A processing example in a case where the leg wheel robot goes up spiral stairs will be described with reference to FIG. 21 and subsequent drawings.

FIG. 21 illustrates an example of spiral stairs.

The stairs are formed to have sequentially higher heights from the stair surface A to the stair surface F, and are formed in a counterclockwise spiral shape as going upward (A to F).

The six-leg type leg wheel robot 100a travels up the spiral stairs.

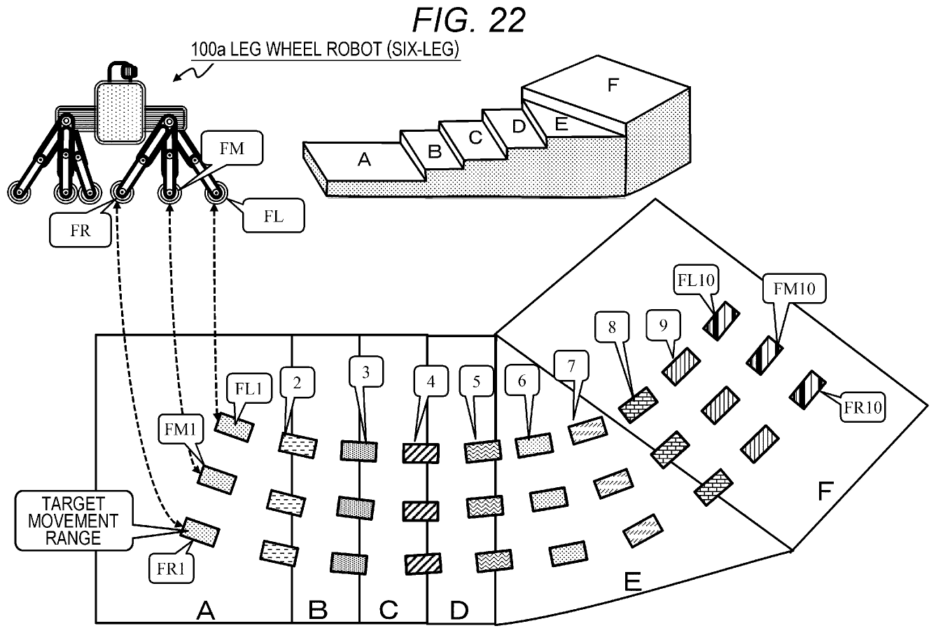

FIG. 22 illustrates an example of target gait data generated by the target gait generation unit 223 of the data processing unit 220 of the moving apparatus 200 illustrated in FIG. 6 in a case where the six-leg type leg wheel robot 100a travels up the spiral stairs.

FIG. 22 illustrates, as a rectangular region, a target movement range of the grounding period of three front legs of the six-leg type leg wheel robot 100a, that is, the front left leg (FL), the front middle leg (FM), and the front right leg (FR).

As described above, the target gait generation unit 223 generates target gait data, that is, target motion sequence data of the robot on the basis of the predefined moving speed information 215 and the predefined target gait parameter as illustrated in FIG. 7. Specifically, the target track such as the leg tip position, the trunk position, and the posture of the target is determined as the “target gait”, that is, the target motion sequence.

The target gait generation unit 223 calculates a track of a future position of the leg tip in a case where ideal traveling according to the target speed=V and the target gait parameter illustrated in FIG. 7 is performed, that is, the target movement range of the grounding period.

FIG. 22 illustrates, as a rectangular region, a target movement range of ten grounding periods of three front legs of the six-leg type leg wheel robot 100a, that is, the front left leg (FL), the front middle leg (FM), and the front right leg (FR).

FL1 illustrated in FIG. 22 is the target movement range of the front left leg (FL) at the start position, 2 to 9 thereafter is the target movement range of the front left leg (FL) in the intermittent grounding period, and FL10 at the end is the target movement range in the last grounding period.

FM1 to FM10 are the target movement range of ten grounding periods of the front middle leg (FM), and FR1 to FR10 are the target movement range of ten grounding periods of the front right leg (FR).

As described above, the target gait generation unit 223 calculates a track of a future position of the leg tip in a case where ideal traveling according to the target speed=V and the target gait parameter illustrated in FIG. 7 is performed, that is, the target movement range of the grounding period.

However, in a case where the target movement range belongs to a plurality of stair surfaces, the robot cannot move while continuing grounding.

For example, the second target movement range [2] of the front left leg (FL) illustrated in FIG. 22 is set to include two stair surfaces of the stair surface A and the stair surface B, and the robot cannot travel with the front left leg (FL) grounded in this target movement range [2].

The same applies to the third target movement range [3] and the fourth target movement range [4] of the front left leg (FL) illustrated in FIG. 22, and the robot cannot travel with the front left leg (FL) grounded also in these target movement ranges [3] and [4].

As for the front middle leg (FM) and the front right leg (FR), there is a plurality of stair surfaces belonging to the target movement range, and traveling with such a leg grounded cannot be performed.

In order to solve such a problem, the movable range determination unit 224 corrects the movement range of each leg in the grounding period.

The movable range determination unit 224 corrects the “target gait” input from the target gait generation unit 223, that is, the target movement range in the grounding period of each leg for moving the robot at the target speed in consideration of the actual travel surface. That is, the corrected movement range corresponding to the actual travel surface is generated.

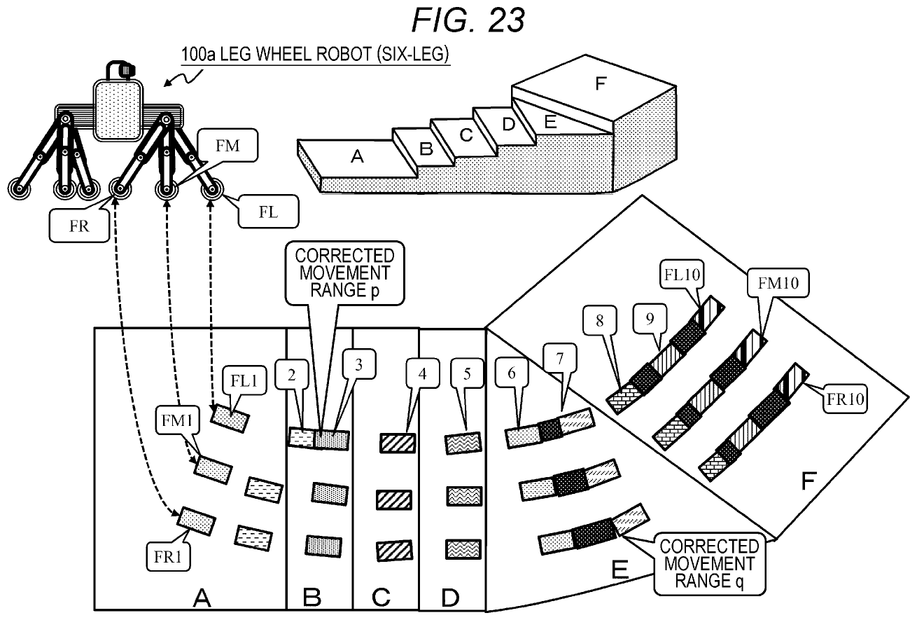

FIG. 23 illustrates correction data generated by the movable range determination unit 224, that is, an example of data of a corrected movement range generated by correcting a target movement range in the grounding period of each leg in consideration of an actual travel surface.

As described above, the movable range determination unit 224 finally performs the following two types of corrected movement range setting processing.
(Correction 1) A target movement range in which it is decided that the continuous grounded traveling cannot be performed is corrected to generate a corrected movement range in which the continuous grounded traveling is possible.
(Correction 2) A corrected movement range in which one continuous grounded traveling is possible is generated by connecting a plurality of separated target movement ranges.

For example, a “corrected movement range p” illustrated in FIG. 23 is an example of a result of the correction processing corresponding to (Correction 1) described above.

As described above with reference to FIG. 22, the second target movement range [2] of the front left leg (FL) illustrated in FIG. 22 is set to include two stair surfaces of the stair surface A and the stair surface B, and the robot cannot travel with the front left leg (FL) grounded in this target movement range [2].

As illustrated in FIG. 23, the movable range determination unit 224 entirely moves the second target movement range [2] of the front left leg (FL) to the stair surface B to generate a new corrected movement range p.

Since such a corrected movement range p belongs to one stair surface B, traveling with the front left leg (FL) grounded can be performed.

Furthermore, for example, a “corrected movement range q” illustrated in FIG. 23 is an example of a result of the correction processing corresponding to (Correction 2) described above.

The sixth target movement range [6] and the seventh target movement range [7] of the front right leg (FR) are both set on a stair surface E. Therefore, when these two target movement ranges are connected, one continuous grounded traveling can be performed.

In such a case, the movable range determination unit 224 connects these two target movement ranges to generate a corrected movement range in which one continuous grounded traveling can be performed.

As described above, note that even if the free leg period is changed to the grounding period, the stability of the robot is not reduced, and more stable traveling can be performed. Thus, the correction processing of increasing the grounding period of the leg is effective for making the robot travel more stably.

The correction data generated by the movable range determination unit 224 illustrated in FIG. 23, that is, rectangular data of the corrected movement range generated by correcting the target movement range in the grounding period of each leg in consideration of an actual travel surface is corrected to a setting in which all belong to one stair surface.

For the three front legs of the six-leg type, it is possible to achieve stable traveling at a predetermined target speed by performing control such that these corrected movement ranges are caused to perform the grounded traveling during the grounding period of each leg.

Note that the corrected movement range of each leg generated by the movable range determination unit 224 is input to the track generation unit 225 illustrated in FIG. 6.

The track generation unit 225 refers to the movable range of the wheel of the tip end of each leg of the robot determined by the movable range determination unit 224, and generates a track of each leg that satisfies the condition that the wheel of the tip end of each leg is set within the movable range and that enables smooth movement according to the predefined moving speed=V, that is, the speed of the “moving speed information 215” illustrated in FIG. 6.

This processing is processing corresponding to the processing described above with reference to FIGS. 18 to 20.

Thereafter, the track information of each leg of the robot generated by the track generation unit 225 is input to the drive unit 226, and the drive unit 226 generates drive information for moving each leg according to the track information of each leg of the robot generated by the track generation unit 225 and drives each leg.

Through these processes, the robot can stably travel without substantially stopping according to the predefined moving speed information 215 (target speed=V).

### 5. Processing Sequence of Generating Track of Leg of Moving Apparatus Performed by Moving Apparatus of Present Disclosure

Next, processing sequence of generating the track of the leg of the moving apparatus performed by the moving apparatus of the present disclosure will be described.

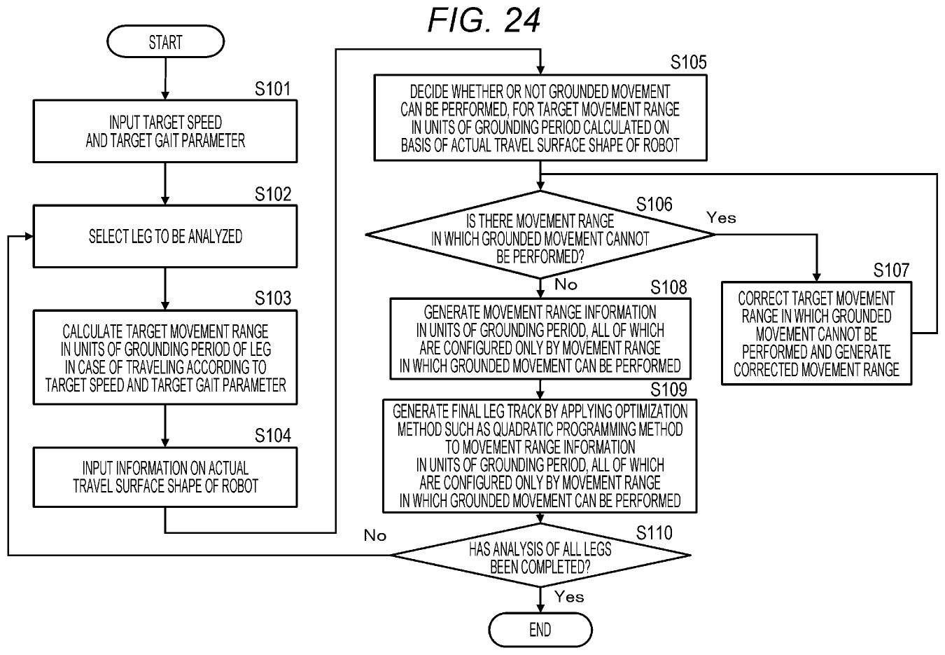

The processing sequence of generating the leg of the moving apparatus performed by the moving apparatus of the present disclosure will be described with reference to the flowchart illustrated in FIG. 24.

Note that the processing of the flowcharts illustrated in FIG. 24 and subsequent drawings are performed in the data processing unit 220 of the moving apparatus 200 of the present disclosure illustrated in FIG. 6. For example, the processing is performed according to a program stored in the storage unit in the moving apparatus 200 under control of the data processing unit having a program execution function such as a CPU. Hereinafter, details of processing of each step of the flow illustrated in FIG. 24 will be sequentially described.

(Step S101)

First, in step S101, the data processing unit 220 of the moving apparatus 200 inputs a target speed and a gait parameter.

This processing is processing performed by the target gait generation unit 223 of the data processing unit 220 of the moving apparatus 200 illustrated in FIG. 6.

As illustrated in FIG. 6, the target gait generation unit 223 externally inputs the target speed=V as the moving speed information 215 illustrated in FIG. 6.

As described above, the moving speed information 215 is a predefined scheduled moving speed of the robot, may be input by a user (operator) via the input unit 211 illustrated in FIG. 6, or information stored in advance in the storage unit 212 may be used as the moving speed information 215. Alternatively, the moving speed information 215 may be received and input from a control device such as an external server via the communication unit 213.

The target gait generation unit 223 generates target gait data, that is, target motion sequence data of the robot on the basis of the moving speed information 215 and the predefined target gait parameter. Specifically, a target track such as a leg tip position, a trunk position, and a posture of the target is determined.

The target gait parameter used to generate the target gait data is, for example, a parameter in which the grounding period and the free leg period of each leg of the robot described above with reference to FIG. 7 are set. The target gait parameter is acquired from the memory in the target gait generation unit 223 or the data processing unit 220. Alternatively, the target gait parameter may be input via the input unit 211, the storage unit 212, and the communication unit 213 illustrated in FIG. 6.

(Step S102)

Next, in step S102, the data processing unit 220 of the moving apparatus 200 selects a leg to be analyzed.

This processing is also processing performed by the target gait generation unit 223 of the data processing unit 220 of the moving apparatus 200 illustrated in FIG. 6. Alternatively, the processing may be performed by a control unit not illustrated in FIG. 6 that performs overall control of the data processing unit 220.

In the selection of the leg to be analyzed in step S102, for example, in a case where the processing target is the six-leg type leg wheel robot 100a as illustrated in FIG. 1, one leg is selected from six legs of the front left leg (FL), the front middle leg (FM), the front right leg (FR), the rear left leg (RL), the rear middle leg (RM), and the rear right leg (RR).

Furthermore, in a case where the processing target is the four-leg type leg wheel robot 100b as illustrated in FIG. 3, one leg is selected from the four legs of the front left leg (FL), the front right leg (FR), the rear left leg (RL), and the rear right leg (RR).

(Step S103)

Next, in step S103, the data processing unit 220 of the moving apparatus 200 performs the following processing on the selected leg to be analyzed.

A target movement range of in units of each grounding period of the leg in a case of traveling according to the target speed and the target gait parameter is calculated.

This processing is also processing performed by the target gait generation unit 223 of the data processing unit 220 of the moving apparatus 200 illustrated in FIG. 6.

The target gait generation unit 223 calculates a track of a future position of the leg tip in a case where ideal traveling according to the target speed=V input in step S101 and the target gait parameter, specifically, for example, the target gait parameter illustrated in FIG. 7 is performed.

In a case where the processing target is the six-leg type leg wheel robot 100a as illustrated in FIG. 1, the movement range of the leg to be analyzed in the grounding period is calculated assuming that the leg to be analyzed performs the uniform motion at the speed=V while alternately changing the free leg period and the grounding period by the stable minimum number of support legs (three legs in this example) according to the target gait parameter illustrated in FIG. 7.

This processing corresponds to the processing described above with reference to FIG. 10 or 12, for example.

For example, processing in a case where the analysis target is the front middle leg (FM) will be described.

As illustrated in FIG. 11, the grounding period of the front middle leg (FM) includes each of the periods of
time=t0 to t1, t2 to t3, t4 to t5, t6 to t7, t8 to t9.
Times of
time=t1 to t2, t3 to t4, t5 to t6, t7 to 8
are the free leg period of the front middle leg (FM).

The front middle leg (FM) moves on the travel surface by rotating the wheel of the leg tip at each of times of
time=t0 to t1, t2 to t3, t4 to t5, t6 to t7, t8 to t9.
that are the grounding period.

A range in which the front middle leg (FM) moves in each grounding period is as follows as illustrated in FIG. 11.
Movement range of time t0 to t1=x0 to x1
Movement range of time t2 to t3=x2 to x3
Movement range of time t4 to t5=x4 to x5
Movement range of time t6 to t7=x6 to x7
Movement range of time t8 to t9=x8 to x9

Note that, since it is assumed that the leg wheel robot 100a performs the uniform motion at the target speed=V, the lengths (moving distances) of the movement ranges at each time are all the same.

As described above, assuming that the leg wheel robot 100a performs a uniform motion with the moving speed information 215 described with reference to FIG. 6, that is, at the speed=V, the target gait generation unit 223 calculates the target movement range of each leg in the grounding period, and generates the “target gait” including the target movement range of each leg.

(Step S104)

Next, in step S104, the data processing unit 220 of the moving apparatus 200 inputs information on an actual travel surface shape of the robot.

This processing corresponds to processing in which the movable range determination unit 224 of the data processing unit 220 of the moving apparatus 200 illustrated in FIG. 6 inputs the shape information of the travel surface from the external environment estimation unit 222.

Specifically, for example, shape information regarding the travel surface such as the stairs on which the robot travels as illustrated in FIG. 9 is input.

(Step S105)

Next, in step S105, the data processing unit 220 of the moving apparatus 200 decides whether or not the grounded movement is possible for each of the target movement ranges in units of the grounding period of the leg calculated in step S103 on the basis of the actual travel surface shape of the robot input in step S104.

This process is performed by the movable range determination unit 224 of the data processing unit 220 of the moving apparatus 200 illustrated in FIG. 6.

This processing corresponds to the processing described above with reference to FIG. 13, for example.

FIG. 13 illustrates a correspondence relationship between the target movement range of each grounding period of the front middle leg (FM), that is,
Movement range of time t0 to t1=x0 to x1
Movement range of time t2 to t3=x2 to x3
Movement range of time t4 to t5=x4 to x5
Movement range of time t6 to t7=x6 to x7
Movement range of time t8 to t9=x8 to x9
and the stair shape, and further, a grounded traveling planned section corresponding to each target movement range and whether or not grounded traveling of each section is possible.

Since the entire range of the movement range=x0 to x1 from time t0 to t1 is included on one stair surface A, traveling by rotating the wheels with the front and middle legs (FM) grounded to the travel surface (A surface) for the entire section of the range=x0 to x1 can be performed.

However, the movement range=x2 to x3 in time t2 to t3 is included on the stair surfaces having two different heights of the stair surface A and the stair surface B.

Therefore, traveling by rotating the wheel with the front middle leg (FM) grounded to the travel surface cannot be performed in the entire section of this range=x2 to x3.

In the example illustrated in FIG. 13, as the decision result,
the movable range determination unit 224 decides that the target movement range=x2 to x3 of time t2 to t3 is included on the stair surfaces having two different heights of the stair surface A and the stair surface B, and continuous grounded traveling cannot be performed. The movable range determination unit 224 decides that all the target movement ranges in the other grounding periods belong to one stair surface and the continuous grounded traveling is possible.

(Step S106)

The processing of step S106 is a branch step of the decision processing of step S105.

In a case where it is decided in step S105 that there is a movement range in which the grounded movement cannot be performed in the movement range of the leg to be analyzed in units of the grounding period, Yes is decided in step S106, and the process proceeds to step S107.

On the other hand, in a case where it is decided in step S105 that there is no movement range in which the grounded movement cannot be performed in the target movement range of the leg to be analyzed in units of the grounding period, No is decided in step S106, and the process proceeds to step S108.

(Step S107)

The processing of step S107 is processing performed in a case where it is decided in step S105 that there is a movement range in which the grounded movement cannot be performed in the movement range of the leg to be analyzed in units of the grounding period.

In this case, in step S107, the data processing unit 220 of the moving apparatus 200 corrects the target movement range in which the grounded movement cannot be performed and generates a corrected movement range.

This processing is also processing performed by the movable range determination unit 224 of the data processing unit 220 of the moving apparatus 200 illustrated in FIG. 6.

This processing corresponds to the processing described above with reference to FIG. 14, for example.

FIG. 14 illustrates an example in which
the movable range determination unit 224 corrects the target movement range=x2 to x3 of time t2 to t3 at which it is decided that the continuous grounded traveling cannot be performed, and
generates the corrected movement range=xp to xq of time t2 to t3.

In the corrected movement range=xp to xq, all the movement ranges are set to belong to one stair surface B.

The target movement range=x2 to x3 of time t2 to t3 generated on the basis of the target speed=V before correction is included on the stair surfaces having two different heights of the stair surface A and the stair surface B, and continuous grounded traveling cannot be performed.

In a case where the target movement range of the grounding time generated on the basis of the target speed=V as described above is in a range in which the continuous grounded traveling is not possible, the movable range determination unit 224 analyzes a stair surface included in the target movement range, selects a stair surface including a large number of target movement ranges, and sets a corrected movement range on the selected stair surface.

In the example illustrated in FIG. 14, the target movement range=x2 to x3 of time t2 to t3 generated on the basis of the target speed=V is included on the stair surfaces having two different heights of the stair surface A and the stair surface B, and about 80% of the target movement range x2 to x3 is included in the stair surface B.

On the basis of this result, the movable range determination unit 224 selects the stair surface B and sets the corrected movement ranges xp to xq in the selected stair surface B.

Note that, in principle, the distance of the corrected movement ranges xp to xq is the same as the distance of the target movement range=x2 to x3 of times t2 to t3 generated on the basis of the target speed=V.

However, in a case where a corrected movement range having the same distance as the distance of the target movement range=x2 to x3 cannot be secured in one selected stair surface, the distance of the corrected movement range is set to be smaller than the distance of the target movement range.

When the processing of generating the corrected movement range in step S107 is completed, the process returns to the decision processing in step S106 again.

In a case where it is decided in step S106 that there is no target movement range in which the grounded movement cannot be performed in the movement range of the leg to be analyzed in units of the grounding period, and the process proceeds to step S108.

(Step S108)

The processing of step S108 is performed in a case where it is determined in step S106 that there is no movement range in which the grounded movement cannot be performed in the target movement range of the leg to be analyzed in units of the grounding period.

In this case, in step S108, the data processing unit 220 of the moving apparatus 200 generates the movement range information in units of the grounding period, all of which are configured only by the movement range in which grounded traveling can be performed.

This processing is also processing performed by the movable range determination unit 224 of the data processing unit 220 of the moving apparatus 200 illustrated in FIG. 6.

For example, the movement range information including the corrected movement range as illustrated in FIG. 14, that is, for example, the movement range information in units of the grounding period, all of which are configured only by the movement range in which the grounded traveling can be performed as follows is generated.
Movement range of time t0 to t1=x0 to x1
Movement range of time t2 to t3=xp to xq
Movement range of time t4 to t5=x4 to x5
Movement range of time t6 to t7=x6 to x7
Movement range of time t8 to t9=x8 to x9

(Step S109)

Next, in step S109, the data processing unit 220 of the moving apparatus 200 performs the following processing.

The final leg track is generated by applying an optimization method such as a quadratic programming method to the movement range information in units of the grounding period, all of which are configured only by the movement range in which grounded traveling can be performed, the movement range information being generated in step S108.

This processing is processing performed by the track generation unit 225 of the data processing unit 220 of the moving apparatus 200 illustrated in FIG. 6.

The track generation unit 226 refers to the movable range of the wheel of the tip end of each leg to be analyzed determined in step S108 by the movable range determination unit 224, and generates a track of the leg that satisfies the condition that the wheel of the tip end of the leg is set within the movable range and that enables smooth movement according to the predefined moving speed=V, that is, the speed of the “moving speed information 215” illustrated in FIG. 6.

This processing corresponds to the processing described above with reference to FIG. 18 or 20, for example.

Note that, as specific track correction processing, for example, track optimization processing is performed using quadratic programming (QP) or the like, which is a representative method of nonlinear programming in mathematical optimization.

An example of the track corrected by this optimization processing is the “track obtained by correcting, by the track generation unit, the front middle leg (MF) track in a case of traveling in the corrected movement range generated by the movable range determination unit” illustrated in FIG. 20 described above.

As described above, the track generation unit 225 refers to the movable range of the wheel of the tip end of each leg of the robot determined by the movable range determination unit 224, and generates a track of the leg that satisfies the condition that the wheel of the tip end of each leg is set within the movable range and that enables smooth movement according to a predefined moving speed, that is, the speed of the “moving speed information 215” illustrated in FIG. 6.

(Step S110)

Next, in step S110, whether or not the analysis of all the legs has been completed is decided.

For example, in a case where the processing target is the six-leg type leg wheel robot 100a as illustrated in FIG. 1, whether or not tracks of all the six legs of the front left leg (FL), the front middle leg (FM), the front right leg (FR), the rear left leg (RL), the rear middle leg (RM), and the rear right leg (RR) have been calculated is decided.

Furthermore, in a case where the processing target is the four-leg type leg wheel robot 100b as illustrated in FIG. 3, whether or not tracks of all the four legs of the front left leg (FL), the front right leg (FR), the rear left leg (RL), and the rear right leg (RR) have been calculated is decided.

This processing is performed by the track generation unit 225 of the data processing unit 220 of the moving apparatus 200 illustrated in FIG. 6 or a control unit not illustrated in FIG. 6 that performs overall control of the data processing unit 220.

In a case where there is a leg that has not been analyzed, the process returns to step S102, and the processing of steps S102 to S109 is performed on the leg that has been individually analyzed.

In a case where it is decided in step S110 that the analysis of all the legs has been completed, the process ends.

By performing the processing according to this flow, the tracks of all the legs of the leg wheel robot are calculated.

That is, a track of each leg is generated, the track being a track that satisfies the condition that the wheel of the tip end of each leg is set within the movable range and that enables smooth movement according to a predefined moving speed, that is, the speed of the “moving speed information 215” illustrated in FIG. 6.

Note that the track information of each leg of the robot generated by the track generation unit 225 is input to the drive unit 226 of the moving apparatus 200 illustrated in FIG. 6.

The drive unit 226 generates drive information for moving each leg according to the track information of each leg of the robot generated by the track generation unit 225 and drives each leg.

Through these processes, the robot can stably travel without substantially stopping according to the predefined moving speed information 215 (target speed=V).

Note that the processing sequence described with reference to the flow illustrated in FIG. 24 does not include the processing described above with reference to FIG. 16.

That is, the processing is not included, the processing being processing of, in a case where the continuous grounded traveling in the grounding period of each leg is possible, and a plurality of separated target movement ranges in a plurality of different grounding periods belongs to one stair surface or the like, setting the plurality of separated target movement ranges as a corrected movement range corresponding to one grounding period by connecting the plurality of separated target movement ranges.

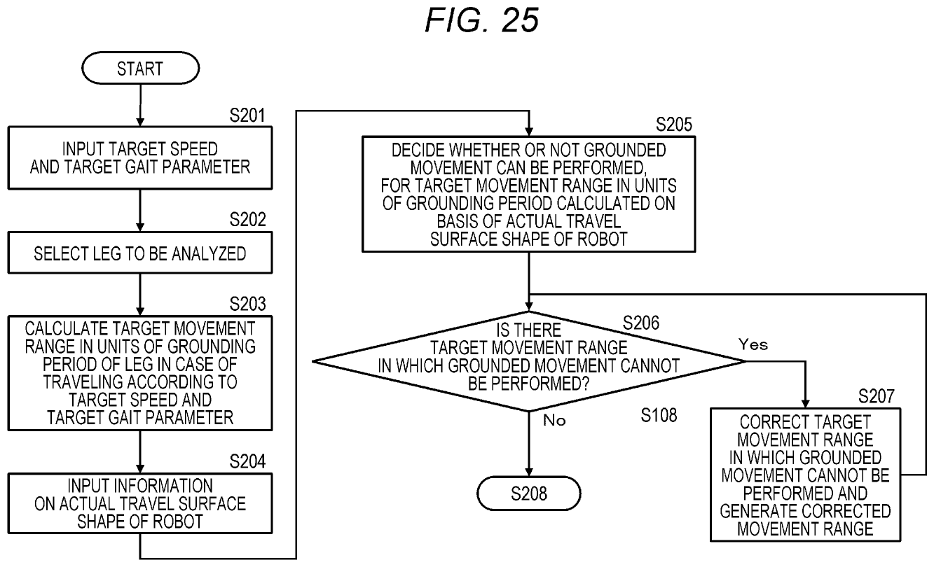

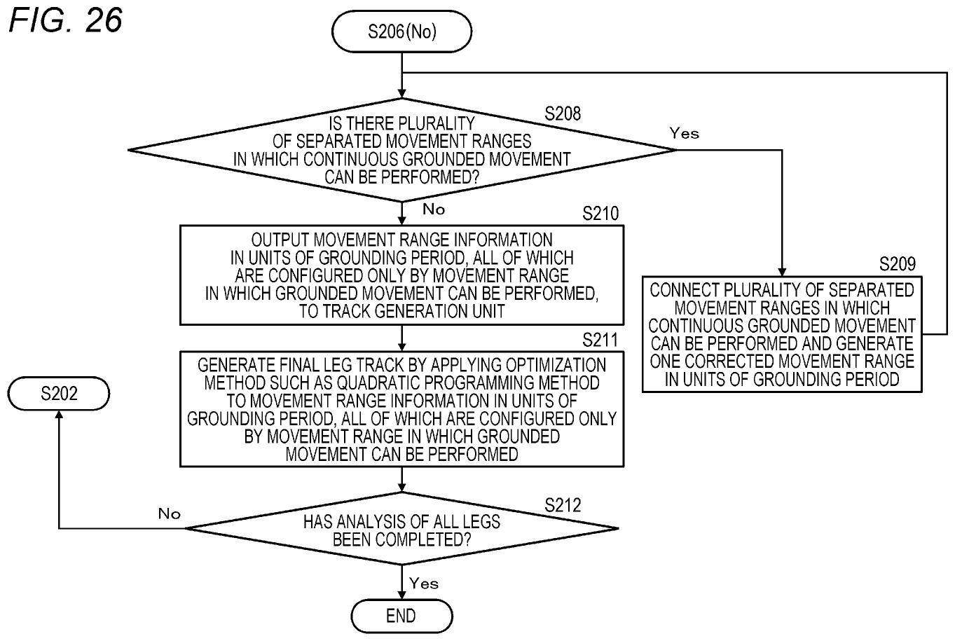

A processing sequence including this processing will be described with reference to a flowchart illustrated in FIGS. 25 to 26.

Hereinafter, processes of respective steps of the flow illustrated in FIGS. 25 and 26 will be described.

(Steps S201 and S207)

Since the processing of steps S201 to S207 is similar to the processing of steps S101 to S107 described above with reference to the flowchart illustrated in FIG. 24, the description will be simplified.

First, in step S201, the target gait generation unit 223 of the data processing unit 220 of the moving apparatus 200 illustrated in FIG. 6 inputs a target speed and a gait parameter.

Next, in step S202, the target gait generation unit 223 or the control unit selects a leg to be analyzed.

Next, in step S203, the target gait generation unit 223 performs the following processing on the leg to be analyzed.

A target movement range of in units of each grounding period of the leg in a case of traveling according to the target speed and the target gait parameter is calculated.

This processing corresponds to the processing described above with reference to FIG. 10 or 12, for example.

Next, in step S204, the movable range determination unit 224 of the data processing unit 220 of the moving apparatus 200 inputs the shape information of the actual travel surface of the robot.

This processing corresponds to processing in which the movable range determination unit 224 of the data processing unit 220 of the moving apparatus 200 illustrated in FIG. 6 inputs the shape information of the travel surface from the external environment estimation unit 222.

Specifically, for example, shape information regarding the travel surface such as the stairs on which the robot travels as illustrated in FIG. 9 is input.

Next, in step S205, the movable range determination unit 224 decides whether or not the grounded movement is possible for each of the target movement ranges in units of the grounding period of the leg calculated in step S203 on the basis of the actual travel surface shape of the robot input in step S204.

This processing corresponds to the processing described above with reference to FIG. 13, for example.

In a case where it is determined in step S205 that there is a movement range in which the grounded movement cannot be performed in the movement range of the leg to be analyzed in units of the grounding period, Yes is determined in step S206, and the process proceeds to step S207.

On the other hand, in a case where it is determined in step S205 that there is no movement range in which the grounded movement cannot be performed in the target movement range of the leg to be analyzed in units of the grounding period, No is determined in step S206, and the process proceeds to step S208.

The processing of step S207 is processing performed in a case where it is determined in step S205 that there is a movement range in which the grounded movement cannot be performed in the movement range of the leg to be analyzed in units of the grounding period.

In this case, in step S207, the movable range determination unit 224 of the data processing unit 220 of the moving apparatus 200 corrects the target movement range in which the grounded movement cannot be performed and generates a corrected movement range.

This processing corresponds to the processing described above with reference to FIG. 14, for example.

When the processing of generating the corrected movement range in step 207 is completed, the process returns to the decision processing in step S206 again.

In a case where it is decided in step S206 that there is no target movement range in which the grounded movement cannot be performed in the movement range of the leg to be analyzed in units of the grounding period, and the process proceeds to step S208.

Since the processing of step S208 and subsequent steps includes processing different from the processing described with reference to FIG. 24, the processing of each step will be sequentially described.

(Step S208)

The processing of step S208 is performed in a case where it is determined in step S206 that there is no movement range in which the grounded movement cannot be performed in the target movement range of the leg to be analyzed in units of the grounding period.

In this case, in step S208, the data processing unit 220 of the moving apparatus 200 decides whether or not there is a plurality of separated movement ranges in which the continuous grounded movement can be performed.

This processing is also processing performed by the movable range determination unit 224 of the data processing unit 220 of the moving apparatus 200 illustrated in FIG. 6.

This processing of step S208 corresponds to the processing described above with reference to FIG. 16.

In the example illustrated in FIG. 16,
the target movement range of time t6 to t7=x6 to x7, and
the target movement range of time t8 to t9=x8 to x9
are both included in one stair surface D, and continuous travel with the front middle leg (FM) grounded on the stair surface D can be performed in the entire period of time t6 to t9.

The movable range determination unit 224 decides whether or not a plurality of separated movement ranges in which the continuous grounded traveling can be performed has been detected as described above.

In a case of being detected, the process proceeds to step S209.

In a case of not being detected, the process proceeds to step S210.

(Step S209)

The processing of step S209 is processing performed in a case where a plurality of separated movement ranges capable of continuous grounding travel is detected in step S208.

This processing in step S209 is also processing performed by the movable range determination unit 224 of the data processing unit 220 of the moving apparatus 200 illustrated in FIG. 6.

In this case, in step S209, the movable range determination unit 224 generates, as one corrected movement range, a plurality of separated target movement ranges in which continuous grounded traveling can be performed.

When the processing of generating the corrected movement range in step 209 is completed, the process returns to the decision processing in step S208 again.

When it is determined in step S208 that there is no plurality of separated movement ranges in which continuous grounded movement can be performed, the process proceeds to step S210.

(Step S210)

Next, in step S210, the data processing unit 220 of the moving apparatus 200 generates the movement range information in units of the grounding period, all of which are configured only by the movement range in which grounded traveling can be performed.

This processing is also processing performed by the movable range determination unit 224 of the data processing unit 220 of the moving apparatus 200 illustrated in FIG. 6.

For example, the movement range information including the corrected movement range as illustrated in FIG. 16, that is, for example, the movement range information in units of the grounding period, all of which are configured only by the movement range in which the grounded traveling can be performed as follows is generated.
Movement range of time t0 to t1=x0 to x1
Movement range of time t2 to t3=xp to xq
Movement range of time t4 to t5=x4 to x5
Movement range of time t6 to t9=x6 to x9

(Step S211)

Next, in step S211, the data processing unit 220 of the moving apparatus 200 performs the following processing.

The final leg track is generated by applying an optimization method such as a quadratic programming method to the movement range information in units of the grounding period, all of which are configured only by the movement range in which grounded traveling can be performed, the movement range information being generated in step S210.

This processing is processing performed by the track generation unit 225 of the data processing unit 220 of the moving apparatus 200 illustrated in FIG. 6.

The track generation unit 226 refers to the movable range of the wheel of the tip end of each leg to be analyzed determined in step S210 by the movable range determination unit 224, and generates a track of the leg that satisfies the condition that the wheel of the tip end of the leg is set within the movable range and that enables smooth movement according to the predefined moving speed=V, that is, the speed of the “moving speed information 215” illustrated in FIG. 6.

This processing corresponds to the processing described above with reference to FIG. 18 or 20, for example.

Note that, as specific track correction processing, for example, track optimization processing is performed using quadratic programming (QP) or the like, which is a representative method of nonlinear programming in mathematical optimization.

An example of the track corrected by this optimization processing is the “track obtained by correcting, by the track generation unit, the front middle leg (MF) track in a case of traveling in the corrected movement range generated by the movable range determination unit” illustrated in FIG. 20 described above.

As described above, the track generation unit 225 refers to the movable range of the wheel of the tip end of each leg of the robot determined by the movable range determination unit 224, and generates a track of the leg that satisfies the condition that the wheel of the tip end of each leg is set within the movable range and that enables smooth movement according to a predefined moving speed, that is, the speed of the “moving speed information 215” illustrated in FIG. 6.

(Step S212)

Next, in step S212, whether or not the analysis of all the legs has been completed is decided.

For example, in a case where the processing target is the six-leg type leg wheel robot 100a as illustrated in FIG. 1, whether or not tracks of all the six legs of the front left leg (FL), the front middle leg (FM), the front right leg (FR), the rear left leg (RL), the rear middle leg (RM), and the rear right leg (RR) have been calculated is decided.

Furthermore, in a case where the processing target is the four-leg type leg wheel robot 100b as illustrated in FIG. 3, whether or not tracks of all the four legs of the front left leg (FL), the front right leg (FR), the rear left leg (RL), and the rear right leg (RR) have been calculated is decided.

This processing is performed by the track generation unit 225 of the data processing unit 220 of the moving apparatus 200 illustrated in FIG. 6 or a control unit not illustrated in FIG. 6 that performs overall control of the data processing unit 220.

In a case where there is a leg that has not been analyzed, the process returns to step S102, and the processing of steps S202 to S211 is performed on the leg that has been individually analyzed.

In a case where it is decided in step S212 that the analysis of all the legs has been completed, the process ends.

By performing the processing according to this flow, the tracks of all the legs of the leg wheel robot are calculated.

That is, a track of each leg is generated, the track being a track that satisfies the condition that the wheel of the tip end of each leg is set within the movable range and that enables smooth movement according to a predefined moving speed, that is, the speed of the “moving speed information 215” illustrated in FIG. 6.

Note that the track information of each leg of the robot generated by the track generation unit 225 is input to the drive unit 226 of the moving apparatus 200 illustrated in FIG. 6.

The drive unit 226 generates drive information for moving each leg according to the track information of each leg of the robot generated by the track generation unit 225 and drives each leg.

Through these processes, the robot can stably travel without substantially stopping according to the predefined moving speed information 215 (target speed=V).

### 6. Hardware Configuration Example of Moving Apparatus of Present Disclosure

Next, a hardware configuration example of the moving apparatus of the present disclosure will be described.

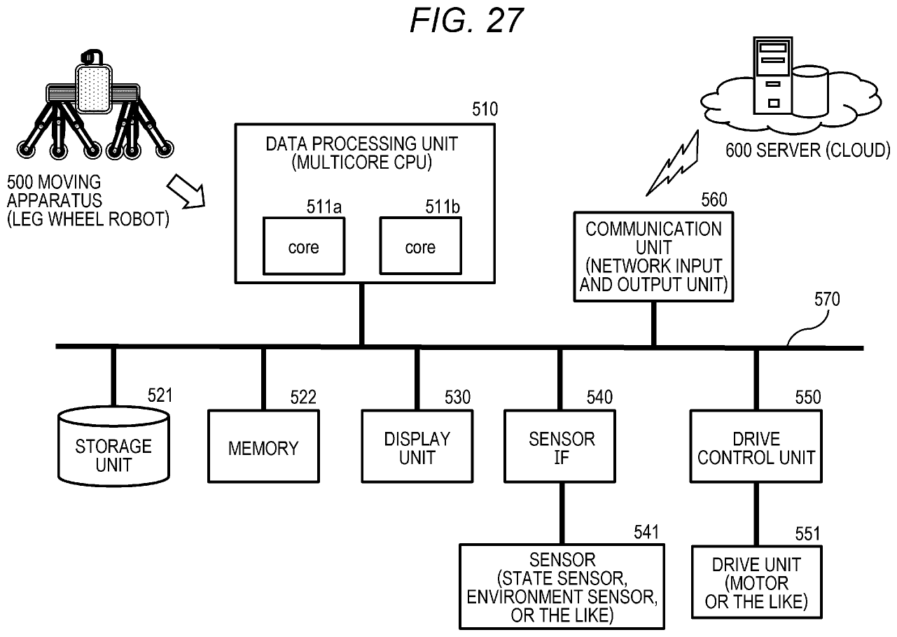

FIG. 27 is a block diagram illustrating a configuration example of a moving apparatus 500 according to the present disclosure.

As illustrated in FIG. 27, the moving apparatus 500 includes a data processing unit 510, a storage unit 521, a memory 522, a display unit 530, a sensor IF 540, a sensor 541, a drive control unit 550, a drive unit 551, a communication unit 560, and a bus 570.

The data processing unit 310 is, for example, a multi-core CPU including a plurality of core CPUs 511a, b, and performs data processing according to each of the above-described embodiments and various other data processing according to a program stored in the storage unit 521 or the memory 522.

The storage unit 521 and the memory 522 store various information necessary for traveling, such as a program executed in the data processing unit 310 and travel route information of the moving apparatus 500.

Furthermore, the area is also used as a storage region for sensor detection information acquired by the sensor 541 including an inertial measurement sensor (IMU), a camera that captures an image, and the like, for example, internal state information, a captured image of an external environment, and data generated in the data processing unit 510.

The display unit 530 is used, for example, as a display unit of various types of information indicating an operation state or the like of the moving apparatus 500 and a display unit of a captured image in the traveling direction. Furthermore, the touch panel may be configured to allow the user to input instruction data.

The sensor IF 540 receives detection information of the sensor 541 such as a visual sensor and outputs the detection information to the data processing unit 510. Alternatively, the sensor detection information is stored in the storage unit 521 or the memory 522.

The sensor 541 includes the state sensor 201, the environment sensor 202, and the like of the moving apparatus 200 described with reference to FIG. 6. For example, the sensor 541 includes an inertial measurement sensor (IMU), a camera that captures an image, or the like.

The drive control unit 550 controls the drive unit 551 including a motor or the like to operate and move the moving apparatus 500.

For example, the data processing unit 510 performs drive processing or the like for arranging the leg in the movement range calculated according to the above-described embodiment.

The communication unit 560 communicates with an external device, for example, a server 600 on the cloud side via a communication network. The server 600 notifies the moving apparatus 500 of a destination, route information for going to the destination, and the like.

The bus 570 is used as a data transfer path between the components.

Note that the server 600 is not an essential component, and may be configured to store a destination, route information for going to the destination, and the like in the moving apparatus 500 and perform processing by the moving apparatus 500 alone.

Furthermore, conversely, a configuration may be adopted in which the server 600 performs the data processing according to the above-described embodiment to determine the control information such as the movement range of the leg of the moving apparatus 500.

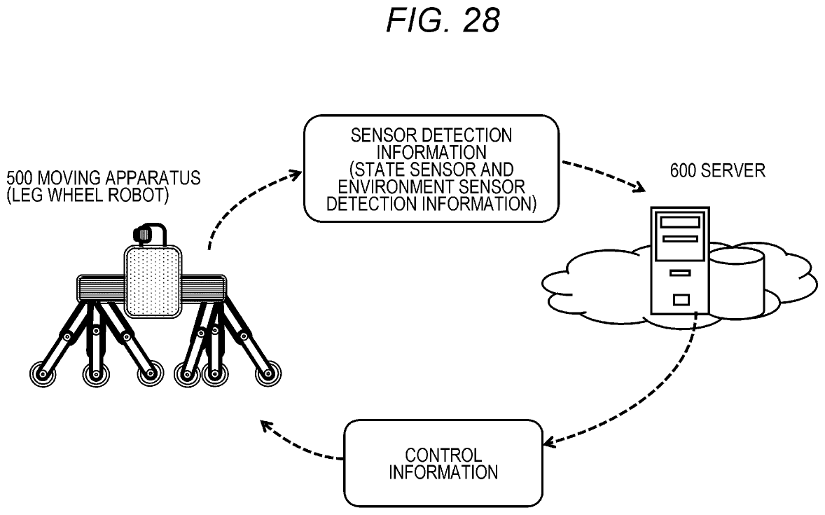

For example, as illustrated in FIG. 28, the moving apparatus 500 and the server 600 are connected by a communication network, and detection information of a sensor configured by, for example, an inertial measurement sensor (IMU) mounted to the moving apparatus 500, a camera that captures an image, or the like is transmitted to the server 600.

The server 600 receives the sensor detection information from the moving apparatus 500, performs data processing according to the above-described embodiment, calculates a movement range, a track, and the like of each leg of the moving apparatus 500, and transmits the calculated track information or drive information generated on the basis of the calculated track information to the moving apparatus 500 as control information.

The moving apparatus 500 drives and moves the legs in accordance with control information received from the server 600, for example, track information and drive information of each leg.

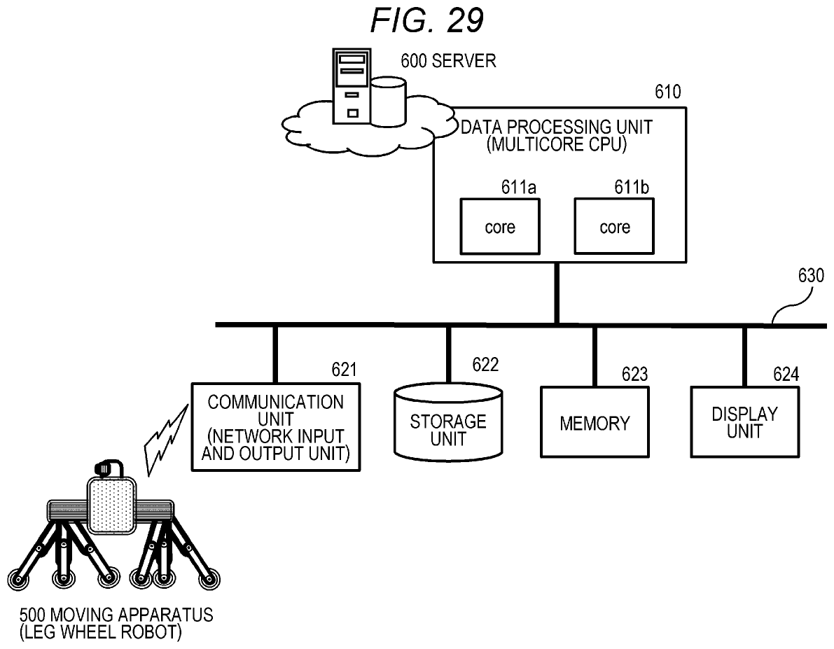

Note that the server 600 that performs data processing as described above has a hardware configuration as illustrated in FIG. 29, for example.

As illustrated in FIG. 29, the server 600 includes a data processing unit 610, a communication unit 621, a storage unit 622, a memory 623, a display unit 624, and a bus 630.

The data processing unit 610 is, for example, a multi-core CPU including a plurality of core CPUs 611a, b, and performs data processing according to each of the above-described embodiments and various other data processing according to a program stored in the storage unit 622 or the memory 623.

The communication unit 621 performs communication with the moving apparatus 500 via a communication network.

For example, the communication unit 621 receives detection information of a sensor configured by an inertial measurement sensor (IMU) of the moving apparatus 500, a camera that captures an image. Furthermore, communication unit 621 transmits the track information and the drive information of each leg generated by the server 600 according to the above-described embodiment to the moving apparatus 500. Furthermore, communication unit 621 may perform processing of transmitting a destination, route information for going to the destination, and the like to the moving apparatus 500.

The storage unit 622 and the memory 623 store various information necessary for traveling, such as a program executed in the data processing unit 610 and travel route information of the moving apparatus 500.

Furthermore, the storage unit 622 and the memory 623 is also used as a storage region of reception data in a case where the sensor detection information acquired by a sensor configured by an inertial measurement sensor (IMU) of the moving apparatus 500, a camera that captures an image, or the like is received via the communication unit 621. Furthermore, the storage unit 622 and the memory 623 is also used as a storage region for data generated by the data processing unit 610.

The display unit 624 is used, for example, as a display unit of various types of information indicating an operation state or the like of the moving apparatus 500 and a display unit of a captured image in the traveling direction. Furthermore, the touch panel may be configured to allow the user to input instruction data.

The bus 630 is used as a data transfer path between the components.

### 7. Summary of Configuration of Present Disclosure

The embodiment of the present disclosure has been described above in detail with reference to the specific embodiment. However, it is self-evident that a person skilled in the art can modify or substitute the embodiment without departing from the gist of the present disclosure. That is, the present invention has been disclosed in the form of exemplification, and should not be interpreted in a limited manner. In order to determine the gist of the present disclosure, the claims should be taken into consideration.

Note that the technology disclosed in the present description can take the following configurations.

(1) A moving apparatus including
a data processing unit that generates control information for driving a leg wheel robot including a plurality of legs each including a wheel at a leg tip,
in which the data processing unit
acquires travel surface information of the leg wheel robot,
calculates a movement range corresponding to each of the legs in which the leg wheel robot can travel with the legs grounded to a travel surface, by using the travel surface information, and
generates track information of each of the legs for causing the leg wheel robot to travel with each of the legs grounded in the movement range corresponding to each of the legs.

(2) The moving apparatus according to (1),
in which the leg wheel robot is configured to
travel while alternately switching between a grounding period in which the wheel at the leg tip is grounded to the travel surface to travel and a free leg period in which the wheel at the leg tip is separated from the travel surface, and
the data processing unit
calculates a movement range corresponding to each of the legs in which the leg wheel robot can travel with the legs grounded to the travel surface in the grounding period, by using the travel surface information.

(3) The moving apparatus according to (1) or (2),
in which the data processing unit
calculates the movement range corresponding to each of the legs for causing the leg wheel robot to travel according to a predefined target speed.

(4) The moving apparatus according to any one of (1) to (3),
in which the data processing unit calculates the movement range corresponding to each of the legs for causing the leg wheel robot to travel according to a predefined gait parameter.

(5) The moving apparatus according to (4),
in which, the gait parameter is a parameter of defining a grounding period in which the wheel at the leg tip is grounded to the travel surface to travel and a free leg period in which the wheel at the leg tip is separated from the travel surface, for each of the legs of the leg wheel robot.

(6) The moving apparatus according to any one of (1) to (5),
in which the data processing unit includes
a target gait generation unit that calculates a target movement range corresponding to each of the legs for causing the leg wheel robot to travel according to a predefined target speed and a predefined gait parameter and
a movable range determination unit that corrects the target movement range, and
the movable range determination unit
decides whether or not the leg wheel robot can travel with the legs grounded to the travel surface in the target movement range, by using the travel surface information, and
in a case where the target movement range is not a movement range in which traveling can be performed with being grounded to the travel surface,
corrects the target movement range to a movement range in which traveling can be performed with being grounded to the travel surface.

(7) The moving apparatus according to (6),
in which the movable range determination unit
decides that the target movement range is not a movement range in which traveling can be performed with being grounded to the travel surface in a case where the target movement range is a travel surface including a plurality of stair surfaces having different heights and
corrects the target movement range to a movement range in one stair surface.

(8) The moving apparatus according to (6) or (7),
in which the movable range determination unit
corrects a plurality of separated target movement ranges to one movement range by connecting the plurality of separated target movement ranges in a case where the plurality of separated target movement ranges belongs to one stair surface.

(9) The moving apparatus according to any one of (6) to (8),
in which the movable range determination unit
inputs a robot state based on detection information of a state sensor that detects an internal state of the leg wheel robot and
external environment information based on detection information of an environment sensor that detects environment information outside the leg wheel robot, and
decides whether or not the leg wheel robot can travel with the legs grounded to the travel surface in the target movement range, by using input information.

(10) The moving apparatus according to any one of (6) to (9),
in which the data processing unit
includes a track generation unit that generates a track corresponding to each of the legs of the leg wheel robot on the basis of the movement range corresponding to each of the legs of the leg wheel robot determined by the movable range determination unit.

(11) The moving apparatus according to (10),
in which the track generation unit
refers to the movement range of the leg wheel robot determined by the movable range determination unit to generate a track of each of the legs that satisfies a condition that the wheel at the tip end of each of the legs is set in the movement range and that enables movement according to a predefined target speed.

(12) The moving apparatus according to (11),
in which the track generation unit performs optimization processing of the track using nonlinear programming.

(13) The moving apparatus according to (12),
in which the track generation unit performs the optimization processing of the track by using quadratic programming (QP) that is a representative method of the optimization processing of the track using nonlinear programming.

(14) The moving apparatus according to any one of (10) to (13),
in which the data processing unit includes a drive unit that generates drive information corresponding to each of the legs for moving each of the legs according to the track information of each of the legs generated by the track generation unit and drives each of the legs.

(15) A moving apparatus control method of performing movement control of a leg wheel robot including a plurality of legs each including a wheel at a leg tip,
in which a data processing unit of the moving apparatus
acquires travel surface information of the leg wheel robot,
calculates a movement range corresponding to each of the legs in which the leg wheel robot can travel with the legs grounded to a travel surface, by using the travel surface information, and
generates track information of each of the legs for causing the leg wheel robot to travel with each of the legs grounded in the movement range corresponding to each of the legs.

Note that a series of processes described in the description can be executed by hardware, software, or a combined configuration of the both. In a case where processing by software is executed, a program in which a processing sequence is recorded can be installed and executed in a memory in a computer incorporated in dedicated hardware, or the program can be installed and executed in a general-purpose computer capable of executing various types of processing. For example, the program can be recorded in advance in a recording medium. In addition to being installed on a computer from a recording medium, the program can be received via a network such as a local area network (LAN) or the Internet and installed on a recording medium such as an internal hard disk.

Furthermore, the various types of processing described in the specification are not only performed in time series according to the description, but may be performed in parallel or individually according to the processing capability of the apparatus that performs the processing or as necessary. Furthermore, in the present specification, a system is a logical set configuration of a plurality of devices, and is not limited to a system in which devices of configurations are in the same housing.

### INDUSTRIAL APPLICABILITY

As described above, according to the configuration of an embodiment of the present disclosure, it is possible to achieve a configuration that enables each leg of the leg wheel robot to be grounded in a movement range corresponding to each leg and to travel according to a predefined target speed even on a travel surface such as a staircase.

Specifically, for example, travel surface information of the leg wheel robot that travels while alternately switching a grounding period in which the traveling is performed with wheels at the leg tips grounded to the travel surface and a free leg period in which the wheels at the leg tips are separated from the travel surface is acquired, a movement range corresponding to each leg in which the legs of the leg wheel robot can travel while being grounded to the travel surface is calculated, and track information of the leg for causing each leg of the leg wheel robot to travel according to a predefined target speed while being grounded to the movement range corresponding to each leg is generated.

According to this configuration, it is possible to achieve a configuration that enables each leg of the leg wheel robot to be grounded in a movement range corresponding to each leg and to travel according to a predefined target speed even on a travel surface such as a staircase.

### REFERENCE SIGNS LIST

100 Leg wheel robot
101 Leg
102 Wheel
103 Rotary joint
104 Linear motion joint
110 Trunk part (trunk)
120 Sensor (camera)
200 Moving apparatus
201 State sensor
202 Environment sensor
211 Input unit
212 Storage unit
213 Communication unit
220 Data processing unit
221 Internal state estimation unit
222 External environment estimation unit
223 Target gait generation unit
224 Movable range determination unit
225 Track generation unit
226 Drive unit
231 Joint part
232 Wheel part
500 Moving apparatus
510 Data processing unit
521 Storage unit
522 Memory
530 Display unit
540 Sensor IF
541 Sensor
550 Drive control unit
551 Drive unit
560 Communication unit
570 Bus
600 Server
610 Data processing unit
621 Communication unit
622 Storage unit
623 Memory
624 Display unit
630 Bus

1. A moving apparatus comprising
a data processing unit that generates control information for driving a leg wheel robot including a plurality of legs each including a wheel at a leg tip,
wherein the data processing unit
acquires travel surface information of the leg wheel robot,
calculates a movement range corresponding to each of the legs in which the leg wheel robot can travel with the legs grounded to a travel surface, by using the travel surface information, and
generates track information of each of the legs for causing the leg wheel robot to travel with each of the legs grounded in the movement range corresponding to each of the legs.

2. The moving apparatus according to claim 1,
wherein the leg wheel robot is configured to
travel while alternately switching between a grounding period in which the wheel at the leg tip is grounded to the travel surface to travel and a free leg period in which the wheel at the leg tip is separated from the travel surface, and
the data processing unit
calculates a movement range corresponding to each of the legs in which the leg wheel robot can travel with the legs grounded to the travel surface in the grounding period, by using the travel surface information.

3. The moving apparatus according to claim 1,
wherein the data processing unit
calculates the movement range corresponding to each of the legs for causing the leg wheel robot to travel according to a predefined target speed.

4. The moving apparatus according to claim 1,
wherein the data processing unit calculates the movement range corresponding to each of the legs for causing the leg wheel robot to travel according to a predefined gait parameter.

5. The moving apparatus according to claim 4,
wherein, the gait parameter is a parameter of defining a grounding period in which the wheel at the leg tip is grounded to the travel surface to travel and a free leg period in which the wheel at the leg tip is separated from the travel surface, for each of the legs of the leg wheel robot.

6. The moving apparatus according to claim 1,
wherein the data processing unit includes
a target gait generation unit that calculates a target movement range corresponding to each of the legs for causing the leg wheel robot to travel according to a predefined target speed and a predefined gait parameter and
a movable range determination unit that corrects the target movement range, and
the movable range determination unit
decides whether or not the leg wheel robot can travel with the legs grounded to the travel surface in the target movement range, by using the travel surface information, and
in a case where the target movement range is not a movement range in which traveling can be performed with being grounded to the travel surface,
corrects the target movement range to a movement range in which traveling can be performed with being grounded to the travel surface.

7. The moving apparatus according to claim 6,
wherein the movable range determination unit
decides that the target movement range is not a movement range in which traveling can be performed with being grounded to the travel surface in a case where the target movement range is a travel surface including a plurality of stair surfaces having different heights and
corrects the target movement range to a movement range in one stair surface.

8. The moving apparatus according to claim 6,
wherein the movable range determination unit
corrects a plurality of separated target movement ranges to one movement range by connecting the plurality of separated target movement ranges in a case where the plurality of separated target movement ranges belongs to one stair surface.

9. The moving apparatus according to claim 6,
wherein the movable range determination unit
inputs a robot state based on detection information of a state sensor that detects an internal state of the leg wheel robot and
external environment information based on detection information of an environment sensor that detects environment information outside the leg wheel robot, and
decides whether or not the leg wheel robot can travel with the legs grounded to the travel surface in the target movement range, by using input information.

10. The moving apparatus according to claim 6,
wherein the data processing unit
includes a track generation unit that generates a track corresponding to each of the legs of the leg wheel robot on a basis of the movement range corresponding to each of the legs of the leg wheel robot determined by the movable range determination unit.

11. The moving apparatus according to claim 10,
wherein the track generation unit
refers to the movement range of the leg wheel robot determined by the movable range determination unit to generate a track of each of the legs that satisfies a condition that the wheel at the tip end of each of the legs is set in the movement range and that enables movement according to a predefined target speed.

12. The moving apparatus according to claim 11,
wherein the track generation unit performs optimization processing of the track using nonlinear programming.

13. The moving apparatus according to claim 12,
wherein the track generation unit performs the optimization processing of the track by using quadratic programming (QP) that is a representative method of the optimization processing of the track using nonlinear programming.

14. The moving apparatus according to claim 10,
wherein the data processing unit includes a drive unit that generates drive information corresponding to each of the legs for moving each of the legs according to the track information of each of the legs generated by the track generation unit and drives each of the legs.

15. A moving apparatus control method of performing movement control of a leg wheel robot including a plurality of legs each including a wheel at a leg tip,
wherein a data processing unit of the moving apparatus
acquires travel surface information of the leg wheel robot,
calculates a movement range corresponding to each of the legs in which the leg wheel robot can travel with the legs grounded to a travel surface, by using the travel surface information, and
generates track information of each of the legs for causing the leg wheel robot to travel with each of the legs grounded in the movement range corresponding to each of the legs.
